(19) United States
(12) Patent Application Publication
(10) Pub. No.: US 2024/0087365 A1
(43) Pub. Date: Mar. 14, 2024

(54) SYSTEMS AND METHODS FOR IDENTIFYING AN OBJECT OF INTEREST FROM A VIDEO SEQUENCE

(71) Applicant: PERCIPIENT .AI INC., Santa Clara, CA (US)

(72) Inventors: Timo PYLVAENAEINEN, Santa Clara, CA (US); Craig SENNABAUM, Santa Clara, CA (US); Mike HIGUERA, Santa Clara, CA (US); Ivan KOVTUN, Santa Clara, CA (US); Atul KANAUJIA, Santa Clara, CA (US); Alison HIGUERA, Santa Clara, CA (US); Jerome BERCLAZ, Santa Clara (US); Rajendra SHAH, Santa Clara, CA (US); Balan AYYAR, Santa Clara, CA (US); Vasudev PARAMESWARAN, Santa Clara, CA (US)

(73) Assignee: PERCIPIENT.AI INC., Santa Clara, CA (US)

(21) Appl. No.: 17/866,396

(22) PCT Filed: Jan. 19, 2021
(86) PCT No.: PCT/US2021/013940

§ 371 Date: Jul. 15, 2022

Related U.S. Application Data
(63) Continuation-in-part of application No. PCT/US21/13932, filed on Jan. 19, 2021.
Application No. PCT/US21/13932 is a continuation-in-part of application No. 16/120,128, filed on Aug. 31, 2018.
Application No. 16/120,128 is a continuation-in-part of application No. PCT/US21/13932, filed on Jan. 19, 2021.
(60) Provisional application No. 62/533,725, filed on Jul. 18, 2017.
(60) Provisional application No. 62/962,928, filed on Jan. 17, 2020.
(60) Provisional application No. 62/962,929, filed on Jan. 17, 2020.
(60) Provisional application No. 63/072,934, filed on Aug. 31, 2020.
(60) Provisional application No. 62/962,929, filed on Jan. 17, 2020.
(60) Provisional application No. 63/072,934, filed on Aug. 31, 2020.
(60) Provisional application No. 62/962,928, filed on Jan. 17, 2020.
(60) Provisional application No. 63/337,595, filed on May 2, 2022.

(51) Int. Cl. G06V 40/16; G06T 7/11; G06T 7/246; G06T 7/90; G06V 10/74; G06V 10/75; G06V 10/762; G06V 10/82

(52) U.S. Cl. CPC G06V 40/173; G06T 7/11; G06T 7/248; G06T 7/90; G06V 10/751; G06V 10/761; G06V 10/762; G06V 10/82; G06V 40/161; G06T 2207/10016; G06T 2207/10024; G06T 2207/20076; G06T 2207/20081; G06T 2207/20084; G06T 2207/20132; G06T 2207/30201; G06T 2207/30232

(57) ABSTRACT

A multisensor processing platform includes, in at least some embodiments, a face detector and embedding network for analyzing unstructured data to detect, identify and track any combination of objects (including people) or activities through computer vision algorithms and machine learning. In some embodiments, the unstructured data is compressed by identifying the appearance of an object across a series of frames of the data, aggregating those appearances and effectively summarizing those appearances of the object by a single representative image displayed to a user for each set of aggregated appearances to enable the user to assess the summarized data substantially at a glance. The data can be filtered into tracklets, groups and clusters, based on system confidence in the identification of the object or activity, to provide multiple levels of granularity.

### RELATED APPLICATIONS

This application is a continuation-in-part of U.S. patent application Ser. No. 16/120,128 filed Aug. 31, 2018, which in turn is a conversion of U.S. Patent Application Ser. No. 62/553,725 filed Sep. 1, 2017. Further, this application is a conversion of U.S. Patent Application Ser. No. 62/962,928 and Ser. No. 62/962,929, both filed Jan. 17, 2020, and also a conversion of U.S. Patent Application Ser. No. 63/072,934, filed Aug. 31, 2020. The present application claims the benefit of each of the foregoing, all of which are incorporated herein by reference.

### FIELD OF THE INVENTION

The present invention relates generally to computer vision systems configured for object recognition and more particularly relates to computer vision systems capable of identifying an object in near real time and scale from a volume of multisensory unstructured data such as audio, video, still frame imagery, or other identifying data in order to assist in contextualizing and exploiting elements of the data relevant to further analysis, such as by compressing identifying data to facilitate a system or user to rapidly distinguish an object of interest from other similar and dissimilar objects. An embodiment relates generally to an object recognition system and, more specifically, to identifying faces of one or more individuals from a volume of video footage or other sensory data, while other embodiments relate to identification of animate and/or inanimate objects from similar types of data.

### BACKGROUND OF THE INVENTION

Conventional computer vision and machine learning systems are configured to identify objects, including people, cars, trucks, etc., by providing to those systems a quantity of training images that are evaluated in a neural network, for example by a convolutional neural network such as shown in FIG. 1. In the absence of such training images, these conventional systems are typically unable to identify the object of interest. In many situations it remains desirable to identify an individual or other object even if there is no picture or similar training image that enables the computer vision system to distinguish the object of interest from other objects having somewhat similar characteristics or features. For example, an observer who has seen an event, such as a person shoplifting, can probably identify the shoplifter if shown a picture, but the shoplifter's face is just one of many images contained in the video footage of the store's security system and there is no conventional way to extract the shoplifter's image from those hundreds or thousands of faces. Conventionally, given the dearth of better data, a sketch artist or a modern digital equivalent would be asked to create a composite image that resembles the suspect. However, this process is time consuming and, often, far from accurate.

Many, if not most, conventional object identification systems that employ computer vision attempt facial recognition where the objects of interest are people. Most such conventional systems have attempted to identify faces of people in the video feed by clustering images of the object, such that each face or individual in a sequence of video footage is represented by selecting a single picture from that footage. While conventional systems implement various embedding approaches, the approach of selecting a single picture typically results in systems that are highly inaccurate because they are typically incapable of selecting an optimal image when the face or individual appears multiple times throughout the video data, but with slight variations in head or body angle, position, lighting, shadowing, etc. Further, such conventional systems typically require significant time to process the volume of images of faces or other objects that may appear in a block of video footage, such as when those faces number in the thousands.

Another challenge faced by conventional facial recognition systems using conventional embedding techniques is the difficulty of mapping all images of the same person or face to exactly the same point in a multidimensional space by conventional facial recognition systems. Additionally, conventional systems operate under the assumption that embeddings from images of the same person are closer to each other than to any embedding of a different person. In reality, there exists a small chance that embeddings of two different people are much closer than two embeddings of the same person, which conventional facial recognition systems fail to account for. In such instances, conventional systems can generate false positives that lead to erroneous conclusions.

The result is that there has been a long felt need for a system that can synthesize accurately a representation of a face or other object by extracting relevant data from video footage, still frame imagery, or other data feed.

### SUMMARY OF THE INVENTION

The present invention is a multisensor processing platform for detecting, identifying and tracking any of entities, objects and activities, or combinations thereof through computer vision algorithms and machine learning. The multisensor data can comprise various types of unstructured data, for example, full motion video, still frame imagery, InfraRed sensor data, communication signals, geo-spatial imagery data, etc. Entities can include faces and their identities, as well as various types of objects such as vehicles, backpacks, weapons, etc. Activities can include correlation of objects, persons and activities, such as packages being exchanged, two people meeting, presence of weapons, vehicles and their operators, etc. In some embodiments, the invention allows human analysts to contextualize their understanding of the multisensor data. For multisensor data flowing in real time, the invention permits such analysis at near real time speed and scale and allows the exploitation of elements of the data that are relevant to their analysis. Embodiments of the system are designed to strengthen the perception of an operator through supervised, semi-supervised and unsupervised learning in an integrated intuitive workflow that is constantly learning and improving the precision and recall of the system.

In at least some embodiments, the multisensor processing platform comprises a face detector and an embedding network. In an embodiment, the face detector generates cropped bounding boxes around detected faces. The platform comprises in part one or more neural networks configured to perform various of the functions of the platform. Depending upon the implementation and the particular function to be performed, the associated neural network can be fully connected, convolutional or other forms as described in the referenced patent applications.

As is characteristic of neural networks, in some embodiments a training process precedes a recognition process. The training step typically involves the use of a training dataset to estimate parameters of a neural network to extract a feature embedding vector for any given image. The resulting universe of embeddings describes a multidimensional space that serves as a reference for comparison during the recognition process.

The present invention comprises two somewhat different major aspects, each of which implements the multisensor processing platform albeit with slightly different functionality. Each has as one of its aspects the ability to provide a user with a representative image that effectively summarizes the appearance of a person or object of interest in a plurality of frames of imagery and thus enables a user to make an “at a glance” assessment of the result of a search. In the first major aspect of the invention, the objective is to identify appearances of a known person or persons of interest within unstructured data such as video footage, where the user generating the query has one or more images of the person or persons. In an embodiment, the neural network of the multisensor processing platform has been trained on a high volume of faces using a conventional training dataset. The facial images within each frame of video are input to the embedding network to produce a feature vector, for example a 128-dimensional vector of unit length. In an embodiment, the embedding network is trained to map facial images of the same individual to a common individual map, for example the same 128-dimension vector. The embedding can be implemented using deep neural networks, among other techniques. Through the use of deep neural networks trained with gradient descent, such an embedding network is continuous and implements differentiable mapping from image space (e.g. 160×160×3 tensors) to, in this case, S¹²⁷, i.e. the unit sphere embedded in 128-dimensional space.

To elaborate, the recognition phase is, in an embodiment, implemented based on one shot or low shot learning depending upon whether the user has a single image of a person of interest such as a driver's license photo or, for greater accuracy, a collection of images of face of the person of interest as a probe image or images. The embedding resulting from processing that image or collection of images enables the system to identify faces that match the person of interest from the gallery of faces in the video footage or other data source. The user's query can be expressed as a Boolean equation or other logical expression, and seeks detection and identification of a specified combination of objects, entities and activities as described above. The query is thus framed in terms of fixed identities, essentially “Find Person A” or “Find Persons A and B” or “Find Persons A and B performing activity C”. On a frame-by-frame basis, each face in the frame is evaluated to determine the likelihood that it is one of the identities in the set {Person A, Person B}. A confidence histogram analysis of pair-wise joint detections of identities can be employed in some embodiments to evaluate the likelihood of any pair of identities being connected. In an embodiment, a linear assignment is used to match the face most likely to be Person A and the face most likely to be Person B.

In the second major aspect of the invention, there is no prior image of the person of interest, who may be known only from an observer's recollection or some other general description, and the objective is to permit a large volume of video footage to be rapidly and accurately summarized, or compressed, in a way that permits either automatic or human browsing of the detected faces so as to identify those detected faces that meet the general description without requiring review of each and every frame. The resulting time savings has the added benefit of increased accuracy, in part due to the fatigue that typically besets a human reviewer after extensive manual review of images.

In this second major aspect faces are identified in a first frame of a data sequence such as video footage, and those images serve as the reference for detecting in a second frame the same faces found in the first frame. The first and second images together serve as references for detecting faces in the third frame, and so on until either the sequence of footage ends or the individual exits the video footage. The collection of images, represented in the platform by their embeddings and sometimes referred to as a tracklet herein, permits the selection of an image for each detected face that is the most representative of their nonvariant features in that entire sequence. Thus, instead of being required to review each and every frame of an entire video sequence, an operator or automated system needs only to scan the representative embeddings. Thus the unstructured data of a video feed that captures a multitude of faces can be compressed into a readily manageable set of thumbnails with substantial savings in time and, potentially, storage space.

Because of the variation in appearance that can occur when an individual travels through the field of view of a camera or other data collector, it is possible that in some embodiments the same person will not be perceived as identical across a series of frames. Thus, one person's face might result in a plurality of tracklets, each with its own representative image. Some of these different representative images are labeled as “key faces” and are grouped together for further processing and resolution. Such a grouping approach is particularly helpful in embodiments where avoiding false positives is a higher priority than avoiding false negatives. The selection of specific representative images as key faces depends at least in part upon the thresholds or tolerances chosen for clustering, and can vary with the specific embodiment or application.

As with the first major aspect of the invention, linear assignment techniques are implemented to determine levels of confidence that a face in a first frame is the same as the face in a second frame, and so on. Further, conditional probability distribution functions of embedding distance can be used to validate the identity of a face detected in a second or later frame as being the same (or different) as a face detected in an earlier frame. Even with multiple key faces, the present invention provides an effective compression of a large volume of unstructured video data into a series of representative images that can be reviewed and analyzed far more quickly and efficiently than possible with the prior art approaches.

In some applications, reducing the data to a more easily manageable volume—i.e., greater data compression—is more useful than ensuring accuracy, while in other applications greater accuracy is more important than reduced volume. The tradeoff between accuracy and compression can be represented as probability distributions, and the desired balance between the two represented as a line as described in greater detail hereinafter.

In some embodiments, color is also important. In such cases, a color histogram in a convenient color space such as CIELAB is extracted from the image. If better generalization is desired, the histogram is blurred which in turn permits matching to nearby colors as well. A Gaussian distribution around the query color can also be used to better achieve a match.

In some embodiments, reporting results to an operator in a curated manner can greatly simplify an operator's review of the data generated by the facial recognition aspects of the present invention. In such embodiments, localized clustering, layout optimization, highlighting, dimming, or blurring, and other similar techniques can all be used to facilitate more rapid assessments without unduly sacrificing accuracy.

It is one object of the present invention to provide a system, method and device by which large volumes of unstructured data can be sorted and inspected, and animate or inanimate objects can be found and tabulated.

It is a further object of the present invention to develop an assessment of objects based on invariant features.

It is another object of the present invention to identify matches to a probe image through the use of per-frame analysis together with Boolean or similar querying.

It is a further object of the present invention to detect faces within each frame of a block of video footage or other sensor data collected over time,

A still further object of the present invention is to assign a representative image to a face detected in a sequence of frames where the representative image is either one of the face captures of an individual or a composite of a plurality of face captures of that individual.

Yet a further object of the present invention is to group faces identified as the same person in a plurality of frames, choose a single image from those faces, and present that single image as representative of that person in that plurality of frames.

Another object of the present invention is to facilitate easy analysis of a video stream by representing as a tracklet the locations of an individual in a series of video frames.

Still another object of the invention is to provide to a user a representative image of each of at least a plurality of the individuals captured in a sequence of images whereby the user can identify persons of interest by browsing the representative images.

A still further object of the present invention is to provide a summary search report to a user comprising a plurality of representative images arranged by level of confidence in the accuracy of the search results.

Yet another object of the invention is to provide search results where certain search results are emphasized relative to other search results by selective highlighting, blurring or dimming.

These and other objects of the invention can be better appreciated from the following Detailed Description of the Invention, taken together with the appended Figures briefly described below.

### THE FIGURES

FIG. 1 [Prior Art] describes a convolutional neural network typical of the prior art.

FIG. 2A shows in generalized block diagram form an embodiment of the overall system as a whole comprising the various inventions disclosed herein.

FIG. 2B illustrates in circuit block diagram form an embodiment of a system suited to host a neural network and perform the various processes of the inventions described herein.

FIG. 2C illustrates in generalized flow diagram form the processes comprising an embodiment of the invention.

FIG. 2D illustrates an approach for distinguishing a face from background imagery in accordance with an aspect of the invention.

FIG. 3A illustrates a single frame of a video sequence comprising multiple frames, and the division of that frame into segments where a face snippet is formed by placing a bounding box placed around the face of an individual appearing in a segment of a frame.

FIG. 3B illustrates in flow diagram form the overall process of retrieving a video sequence, dividing the sequence into frames and segmenting each frame of the video sequence.

FIG. 4 illustrates in generalized flow diagram form the process of analyzing a face snippet in a first neural network to develop an embedding, followed by further processing and classification.

FIG. 5A illustrates a process for evaluating a query in accordance with an embodiment of an aspect of the invention.

FIG. 5B illustrates an example of a query expressed in Boolean logic.

FIG. 6 illustrates a process in accordance with an embodiment of the invention for detecting faces or other objects in response to a query.

FIG. 7A illustrates a process in accordance with an embodiment of the invention for creating tracklets for summarizing detection of a person of interest in a sequence of frames of unstructured data such as video footage.

FIG. 7B illustrates how the process of FIG. 7A can result in grouping tracklets according to confidence level.

FIG. 8 is a graph of two probability distribution curves that depict how a balance between accuracy and data compression can be selected based on embedding distances, where the balance, and thus the confidence level associated with a detection or a series of detections, can be varied depending upon the application or the implementation.

FIG. 9 illustrates a process in accordance with an aspect of the invention for determining a confidence metric that two or more individuals are acting together.

FIG. 10 illustrates the detection of a combination of faces and objects in accordance with an embodiment of an aspect of the invention.

FIG. 11 illustrates in generalized flow diagram form an embodiment of the second aspect of the invention.

FIG. 12 illustrates a process in accordance with an embodiment of an aspect of the invention for developing tracklets representing a record of an individual or object throughout a sequence of video frames, where an embedding is developing for each frame in which the individual or object of interest is detected.

FIG. 13 illustrates a process for determining a representative embedding from the tracklet's various embeddings.

FIGS. 14A-14B illustrate a layout optimization technique for organizing tracklets on a grid in accordance with an embodiment of the invention.

FIG. 15A illustrates a simplified view of clustering in accordance with an aspect of the invention.

FIG. 15B illustrates in flowchart form an exemplary embodiment for localized clustering of tracklets in accordance with an embodiment of the invention.

FIG. 15C illustrates a visualization of the clustering process of Figure of FIG. 15B.

FIG. 15D illustrates the result of the clustering process depicted in the embodiment of FIGS. 15B and 15C.

FIG. 16A illustrates a technique for highlighting similar tracklets in accordance with an embodiment of the invention.

FIGS. 16B-16C illustrate techniques for using highlighting and dimming as a way of emphasizing tracklets of greater interest in accordance with an embodiment of the invention.

FIG. 17 illustrates a curation and optional feedback technique in accordance with an embodiment of the invention.

FIG. 18A-18C illustrate techniques for incorporating detection of color through the use of histograms derived from a defined color space.

FIG. 19 illustrates a report and feedback interface for providing a system output either to an operator or an automated process for performing further analysis.

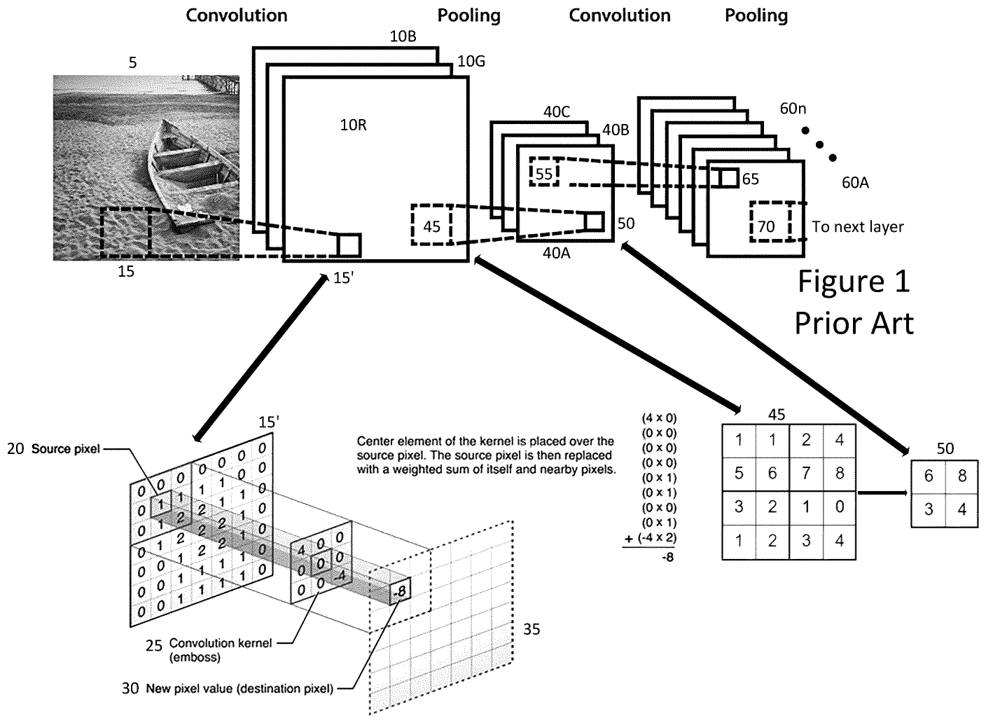

### DETAILED DESCRIPTION OF THE INVENTION

As discussed briefly above, the present invention comprises a platform for quickly analyzing the content of a large amount of unstructured data, as well as executing queries directed to the content regarding the presence and location of various types of entities, inanimate objects, and activities captured in the content. For example, in full motion video, an analyst might want to know if a particular individual is captured in the data and if so the relationship to others that may also be present. An aspect of the invention is the ability to detect and recognize persons, objects and activities of interest using multisensor data in the same model substantially in real time with intuitive learning.

Viewed from a high level, the platform of the present invention comprises an object detection system which in turn comprises an object detector and an embedding network. The object detector is trainable to detect any class of objects, such as faces as well as inanimate objects such cars, backpacks, and so on.

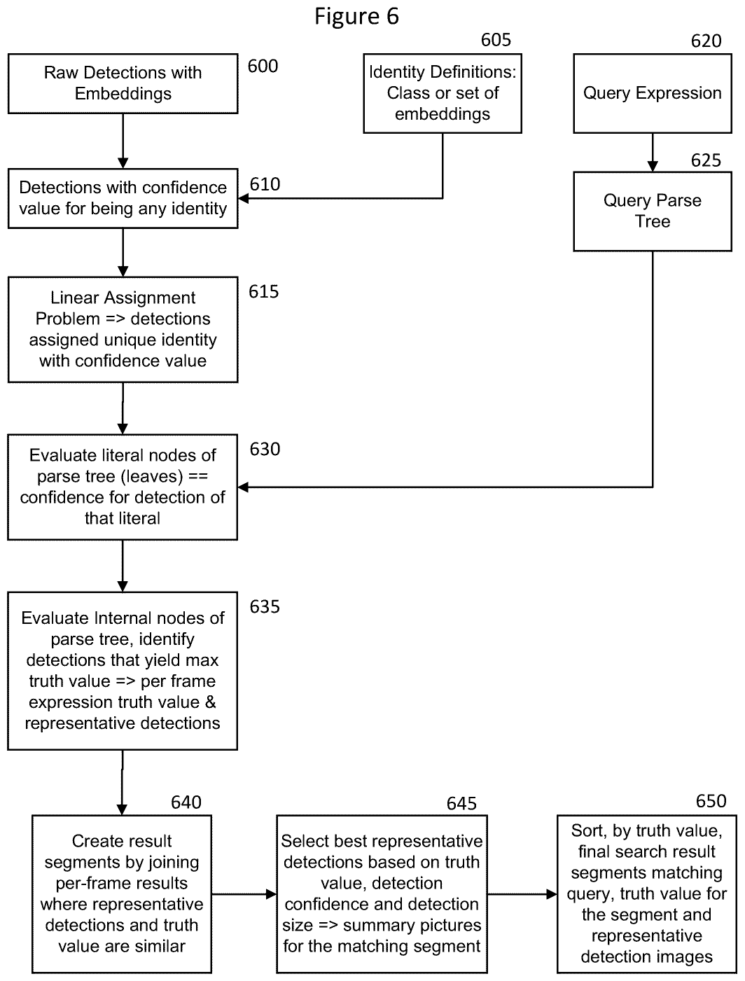

Drilling down, an embodiment of the platform comprises the following major components: a chain of processing units, a data saver, data storage, a reasoning engine, web services, report generation, and a User Interface. The processing units comprise a face detector, an object detector, an embedding extractor, clustering, an encoder, and person network discovery. In an embodiment, the face detector generates cropped bounding boxes around faces in an image such as a frame, or a segment of a frame, of video. In some such embodiments, video data supplemented with the generated bounding boxes may be presented for review to an operator or a processor-based algorithm for further review, such as to remove random or false positive bounding boxes, add bounding boxes around missed faces, or a combination thereof. It will be appreciated by those skilled in the art that the term “segment” is used herein in two different contexts, with a different meaning depending upon the context. As noted above, a frame can be divided into multiple pieces, or segments. However, as discussed in connection with FIGS. 6A-6B et seq., a sequence of video data is sometimes described as a segment.

As noted above, in an embodiment the facial images within each frame are inputted to the embedding network to produce a feature vector for each such facial image, for example a 128-dimensional vector of unit length. The embedding network is trained to map facial images of the same individual to a common individual map, for example the same 128-dimension vector. Because of how deep neural networks are trained if the training involves the use of gradient descent, such an embedding network is a continuous and differentiable mapping from image space (e.g. 160×160×3 tensors) to, in this case, S¹²⁷, i.e. the unit sphere embedded in 128-dimensional space. Accordingly, the difficulty of mapping all images of the same person to exactly the same point is a significant challenge experienced by conventional facial recognition systems.

Although there are two major aspects to the present invention, both aspects share a common origin in the multisensor processing system and many of the functionalities extant in that system. Thus, the platform and its functionalities are discussed first hereinafter, followed by a discussion of the first major aspect and then the second major aspect, as described in the Summary of the Invention, above.

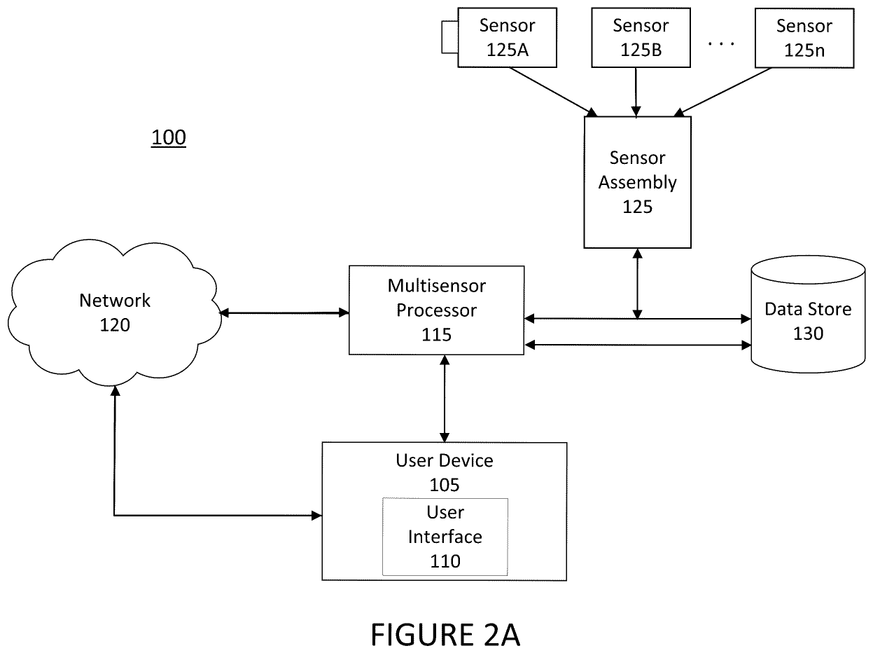

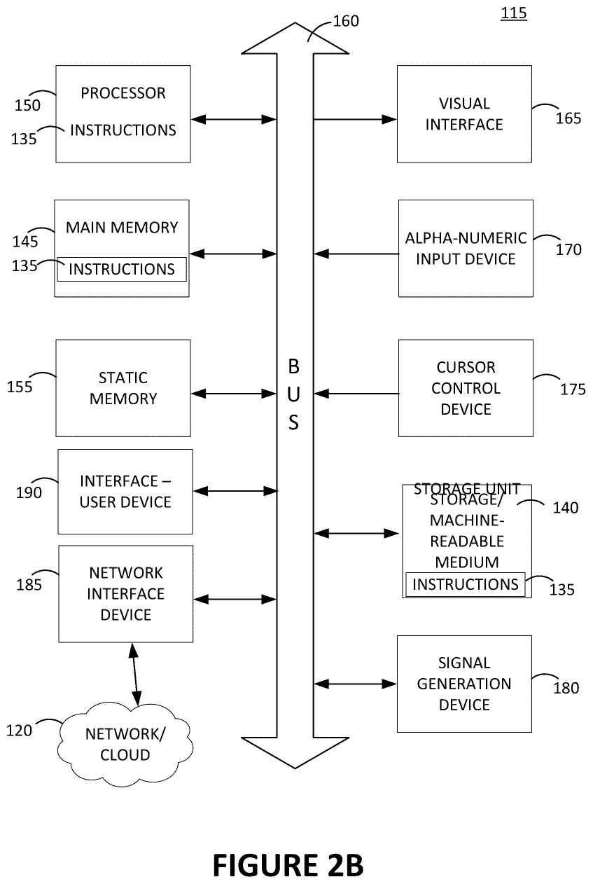

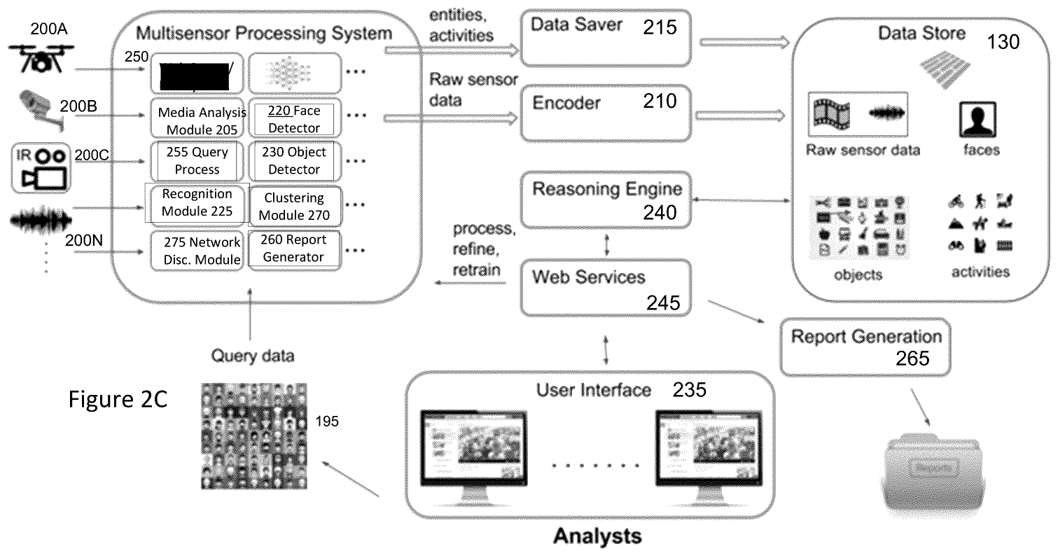

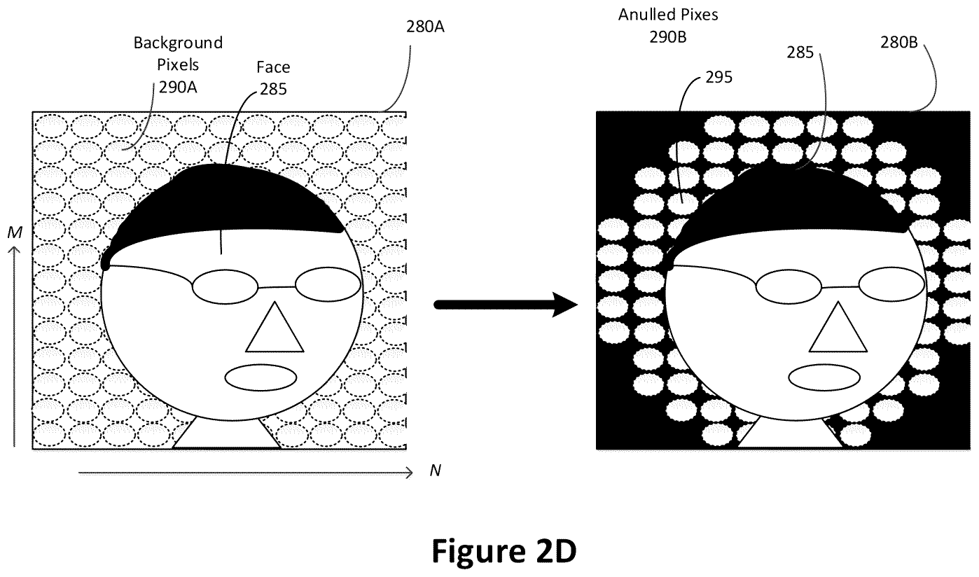

Referring first to FIG. 2A, shown therein is a generalized view of an embodiment of a system 100 and its processes comprising the various inventions as described hereinafter. The system 100 can be appreciated in the whole. The system 100 comprises a user device 105 having a user interface 110. A user of the system communicates with a multisensor processor 115 either directly or through a network connection which can be a local network, the internet, a private cloud or any other suitable network. The multisensory processor, described in greater detail in connection with FIG. 2B, receives input from and communicates instructions to a sensor assembly 125 which further comprises sensors 125A-125n. The sensor assembly can also provide sensor input to a data store 130, and in some embodiments can communicate bidirectionally with the data store 130.

Next with reference to FIG. 2B, shown therein in block diagram form is an embodiment of the multisensor processor system or machine 115 suitable for executing the processes and methods of the present invention. In particular, the processor 115 of FIG. 2B is a computer system that can read instructions 135 from a machine-readable medium or storage unit 140 into main memory 145 and execute them in one or more processors 150. Instructions 135, which comprise program code or software, cause the machine 115 to perform any one or more of the methodologies discussed herein. In alternative embodiments, the machine 115 operates as a standalone device or may be connected to other machines via a network or other suitable architecture. In a networked deployment, the machine may operate in the capacity of a server machine or a client machine in a server-client network environment, or as a peer machine in a peer-to-peer (or distributed) network environment. In some embodiments, system 100 is architected to run on a network, for example, a cloud network (e.g., AWS) or an on-premise data center network.

The multisensor processor 115 can be a server computer such as maintained on premises or in a cloud network, a client computer, a personal computer (PC), a tablet PC, a set-top box (STB), a personal digital assistant (PDA), a cellular telephone, a smartphone, a web appliance, a network router, switch or bridge, or any machine capable of executing instructions 135 (sequential or otherwise) that specify actions to be taken by that machine. Further, while only a single machine is illustrated, the term “machine” shall also be taken to include any collection of machines that individually or jointly execute instructions 135 to perform any one or more of the methods or processes discussed herein.

In at least some embodiments, the multisensor processor 115 comprises one or more processors 150. Each processor of the one or more processors 150 can comprise a central processing unit (CPU), a graphics processing unit (GPU), a digital signal processor (DSP), a controller, one or more application specific integrated circuits (ASICs), one or more radio-frequency integrated circuits (RFICs), or any combination of these. In an embodiment, the machine 115 further comprises static memory 155 together with main memory 145, which are configured to communicate with each other via bus 160. The machine 115 can further include one or more visual displays as well as associated interfaces, all indicated at 165, for displaying messages or data. The visual displays may be of any suitable type, such as monitors, head-up displays, windows, projectors, touch enabled devices, and so on. At least some embodiments further comprise an alphanumeric input device 170 such as a keyboard, touchpad or touchscreen or similar, together with a pointing or other cursor control device 175 such as a mouse, a trackball, a joystick, a motion sensor, a touchpad, a tablet, and so on), a storage unit or machine-readable medium 140 wherein the machine-readable instructions 135 are stored, a signal generation device 180 such as a speaker, and a network interface device 185. A user device interface 190 communicates bidirectionally with user devices 120 (FIG. 2A). In an embodiment, all of the foregoing are configured to communicate via the bus 160, which can further comprise a plurality of buses, including specialized buses, depending upon the particular implementation.

Although shown in FIG. 2B as residing in storage unit or machine-readable medium 140, instructions 135 (e.g., software) for causing the execution of any of the one or more of the methodologies, processes or functions described herein can also reside, completely or at least partially, within the main memory 145 or within the processor 150 (e.g., within a processor's cache memory) during execution thereof by the multisensor processor 115. In at least some embodiments, main memory 145 and processor 150 also can comprise, in part, machine-readable media. The instructions 135 (e.g., software) can also be transmitted or received over a network 120 via the network interface device 185.

While machine-readable medium or storage device 140 is shown in an example embodiment to be a single medium, the term “machine-readable medium” should be taken to include a single medium or multiple media (e.g., a centralized or distributed database, or associated caches and servers) able to store instructions (e.g., instructions 135). The term “machine-readable medium” includes any medium that is capable of storing instructions (e.g., instructions 135) for execution by the machine and that cause the machine to perform any one or more of the methodologies disclosed herein. The term “machine-readable medium” includes, but is not limited to, data repositories in the form of solid-state memories, optical media, and magnetic media. The storage device 140 can be the same device as data store 130 (FIG. 2A) or can be a separate device which communicates with data store 130.

FIG. 2C illustrates, at a high level, an embodiment of the software functionalities implemented in an exemplary system 100 shown generally in FIG. 2A, including an embodiment of those functionalities operating in the multisensor processor 115 shown in FIG. 2B. Thus, inputs 200A-200n can be video or other sensory input from a drone 200A, from a security camera 200B, a video camera 2000, or any of a wide variety of other input device 200n capable of providing data sufficient to at least assist in identifying an animate or inanimate object. It will be appreciated that combinations of different types of data can be used together for the analysis performed by the system. For example, in some embodiments, still frame imagery can be used in combination with video footage. In other embodiments, a series of still frame images can serve as the gallery. Still further, while organizing the input feed chronologically is perhaps the most common, arranging the input data either by lat/long or landmarks or relative position to other data sources, or numerous other methods, can also be used in the present invention. Further, the multisensor data can comprise live feed or previously recorded data. The data from the sensors 200A-200n is ingested by the processor 115 through a media analysis module 205. In addition to the software functionalities operating within the multisensor processor 115, described in more detail below, the system of FIG. 2C comprises encoders 210 that receive entities (such as faces and/or objects) and activities from the multisensor processor 115. Further, a data saver 215 receives raw sensor data from processor 115, although in some embodiments raw video data can be compressed using video encoding techniques such as H.264 or H.265. Both the encoders and the data saver provide their respective data to the data store 130 in the form of raw sensor data from data saver 210 and faces, objects, and activities from encoders 205. Where the sensor data is video, the raw sensor data can be compressed in either the encoders or the data saver using video encoding techniques, for example, H.264 & H.265 encoding.

Where the multisensor data from inputs 200A-200n includes full motion video from terrestrial or other sensors, the processor 115 can, in an embodiment, comprise a face detector 220 chained with a recognition module 225 which comprises an embedding extractor, and an object detector 230. In an embodiment, the face detector 220 and object detector 230 can employ a single shot multibox detector (SSD) network, which is a form of convolutional neural network. SSD's characteristically perform the tasks of object localization and classification in a single forward pass of the network, using a technique for bounding box regression such that the network both detects objects and also classifies those detected objects. Using, for example, the FaceNet neural network architecture, the face recognition module 225 represents each face with an “embedding”, which is a 128 dimensional vector designed to capture the identity of the face, and to be invariant to nuisance factors such as viewing conditions, the person's age, glasses, hairstyle, etc. Alternatively, various other architectures, of which SphereFace is one example, can also be used. In embodiments having other types of sensors, other appropriate detectors and recognizers may be used. Machine learning algorithms may be applied to combine results from the various sensor types to improve detection and classification of the objects, e.g., faces or inanimate objects. In an embodiment, the embeddings of the faces and objects comprise at least part of the data saved by the data saver 210 and encoders 205 to the data store 130. The embedding and entities detections, as well as the raw data, can then be made available for querying, which can be performed in near real time or at some later time.

Queries to the data are initiated by analysts or other users through a user interface 235 which connects bidirectionally to a reasoning engine 240, typically through network 120 (FIG. 2A) via a web services interface 245. In an embodiment, the web services interface 245 can also communicate with the modules of the processor 115, typically through a web services external system interface 250. The web services comprise the interface into the back-end system to allow users to interact with the system. In an embodiment, the web services use the Apache web services framework to host services that the user interface can call, although numerous other frameworks are known to those skilled in the art and are acceptable alternatives.

Queries are processed in the processor 115 by a query process 255. The user interface 235 allows querying of the multisensor data for faces and objects (collectively, entities) and activities. One exemplary query can be “Find all images in the data from multiple sensors where the person in a given photograph appears”. Another example might be, “Did John Doe drive into the parking lot in a red car, meet Jane Doe, who handed him a bag”. Alternatively, in an embodiment, a visual GUI can be helpful for constructing queries. The reasoning engine 240, which typically executes in processor 115, takes queries from the user interface via web services and quickly reasons through, or examines, the entity data in data store 130 to determine if there are entities or activities that match the analysis query. In an embodiment, the system geo-correlates the multisensor data to provide a comprehensive visualization of all relevant data in a single model. Once that visualization of the relevant data is complete, a report generator module 260 in the processor 115 saves the results of various queries and generates a report through the report generation step 265. In an embodiment, the report can also include any related analysis or other data that the user has input into the system.

The data saver 215 receives output from the processing system and saves the data on the data store 130, although in some embodiments the functions may be integrated. In an embodiment, the data from processing is stored in a columnar data storage format such as Parquet that can be loaded by the search backend and searched for specific embeddings or object types quickly. The search data can be stored in the cloud (e.g. AWS S3), on premise using HDFS (Hadoop Distributed File System), NFS, or some other scalable storage. In some embodiments, web services 245 together with user interface (UI) 235 provide users such as analysts with access to the platform of the invention through a web-based interface. The web based interface provides a REST API to the UI. The web based interface, in turn, communicates with the various components with remote procedure calls implemented using Apache Thrift. This allows various components to be written in different languages.

In an embodiment, the UI is implemented using React and node.js, and is a fully featured client side application. The UI retrieves content from the various back-end components via REST calls to web service. The User Interface supports upload and processing of recorded or live data. The User Interface supports generation of query data by examining the recorded or live data. For example, in the case of video, it supports generation of face snippets from uploaded photograph or from live video, to be used for querying. Upon receiving results from the Reasoning Engine via the Web Service, the UI displays results on a webpage.

In some embodiments, the UI allows a human to inspect and confirm results. When confirmed the results can be augmented with the query data as additional examples, which improves accuracy of the system. The UI augments the raw sensor data with query results. In the case of video, results include keyframe information which indicates—as fractions of the total frame dimensions—the bounding boxes of the detections in each frame that yielded the result. When the corresponding result is selected in the UI, the video is overlaid by the UI with visualizations indicating why the algorithms believe the query matches this portion of the video. An important benefit of this aspect of at least some embodiments is that such summary visualizations support “at a glance” verification of the correctness of the result. This ease of verification becomes more important when the query is more complex. Thus, if the query is “Did John drive a red car to meet Jane, who handed him a bag”, a desirable result would be a thumbnail, viewable by the user, that shows John in a red car and receiving an object from Jane. One way of achieving this is to display confidence measures as reported by the Reasoning Engine. Using fractions instead of actual coordinates makes the data independent of the actual video resolution, which makes it easy to provide encodings of the video at various resolutions.

Continuing the use of video data as an example, in an embodiment the UI displays a bounding box around each face, creating a face snippet. As the video plays back, the overlay is interpolated from key-frame to key-frame, so that bounding box information does not need to be transmitted for every frame. This decouples the video (which needs high bandwidth) from the augmentation data (which only needs low bandwidth). This also allows caching the actual video content closer to the client. While the augmentations are query and context specific and subject to change during analysts' workflow, the video remains the same.

In some embodiments, certain pre-filtering of face snippets may be performed before face embeddings are extracted. For example, the face snippet can be scaled to a fixed size, typically but not necessarily square, of 160×160 pixels. In many instances, the snippet with the individual's face will also include some pixels from the background, which are not helpful to the embedding extraction. Likewise, it is desirable for the embeddings to be as invariant as possible to rotation or tilting of the face. This is best achieved by emphasizing the true face of the individual, and de-emphasizing the background. Since an individual's face typically occupies a central portion of the face snippet, one approach is to identify, during training, an average best radius which can then be used during run time, or recognition. An alternative approach is to detect landmarks, such as eyes, nose, mouth, ears, using any of the face landmark detection algorithms known to those skilled in the art. Knowledge of the eyes, for example, will allow us to define a more precise radius based upon the eye locations. For example, we might set the radius as R=s*d_e, where d_e is the average distance of each eye from the center of the scaled snippet, and s is a predetermined scaling factor.

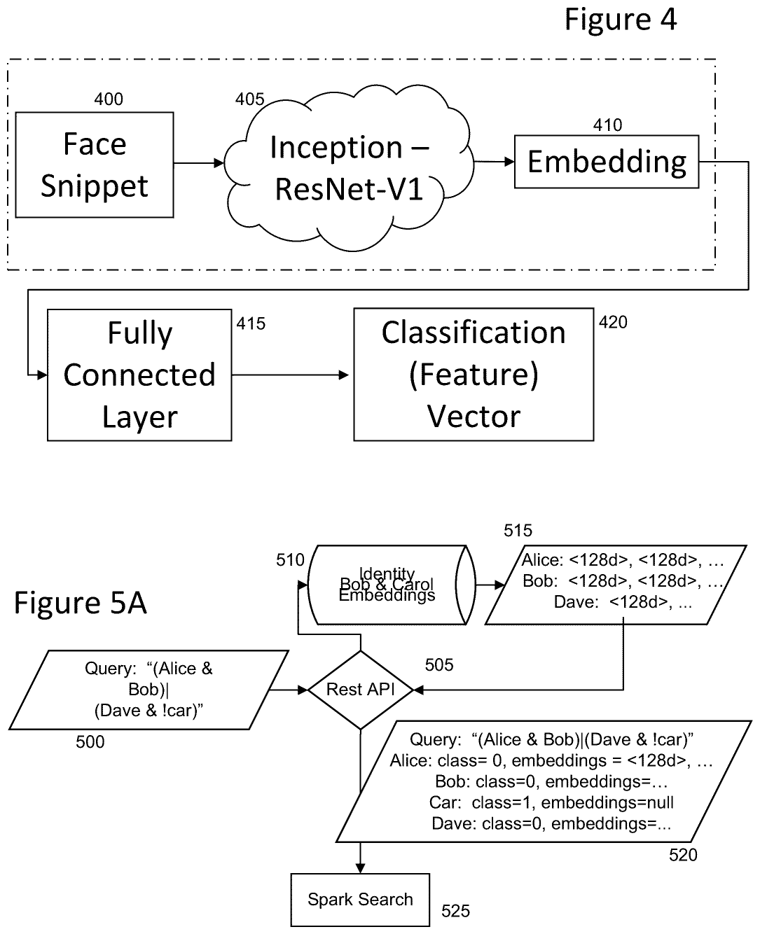

Regardless of the method used to identify background from the actual face, once that is complete, the background is preferably eliminated or at least deemphasized. Referring to FIG. 2D, a vignetting or filtering technique used in connection with the aforementioned bounding boxes and face snippets can be better appreciated. In most segments of a video frame, the bounding box that surrounds a detected face includes aspects of the background that are not relevant to the detection. Through a vignetting or filtering technique, that irrelevant data is excised. Thus, bounding box 280A includes a face 285 and background pixels 290A. By applying a vignetting filter or other suitable algorithmic filter, the background pixels 290A are annulled, or “zeroed out”, and bounding box 290A becomes box 290A where face 285 is surrounded by 290B. A separation layer 295, comprising a few pixels for example, can be provided between the face 285 and the annulled pixels 290A to help ensure that no relevant pixels are lost through the filtering step. The annulled pixels can be the result of any suitable technique, for example being darkened, blurred, or converted to a color easily distinguished from the features of the face or other object. More details of the sequence for isolating the face will be discussed hereinafter in connection with FIG. 4.

The video processing platform for recognition of objects within video data provides functionality for analysts to more quickly, accurately, and efficiently assess large amounts of video data than historically possible and thus to enable the analysts to generate reports 265 that permit top decision-makers to have actionable information more promptly. The video processing platform for recognition within video data enables the agent to build a story with his notes and a collection of scenes or video snippets. Each of these along with the notes provided can be organized in any order or time order. The report automatically provides a timeline view or geographical view on a map.

To better understand the operation of the system of the first major aspect of the invention, where the objective is to identify appearances of a known person in unstructured data, and where at least one image of the person of interest is available, consider the example of an instantiation of the multisensor processor system where the multisensor data includes full motion video. In such an instance, the relevant processing modules include the face detector 220, the recognition module 225, the object detector 230, a clustering module 270 and a person network discovery module 275. The instantiation also includes the encoders 210, the data saver 215, the data store 130, the reasoning engine 240, web services 245, and the user interface 235.

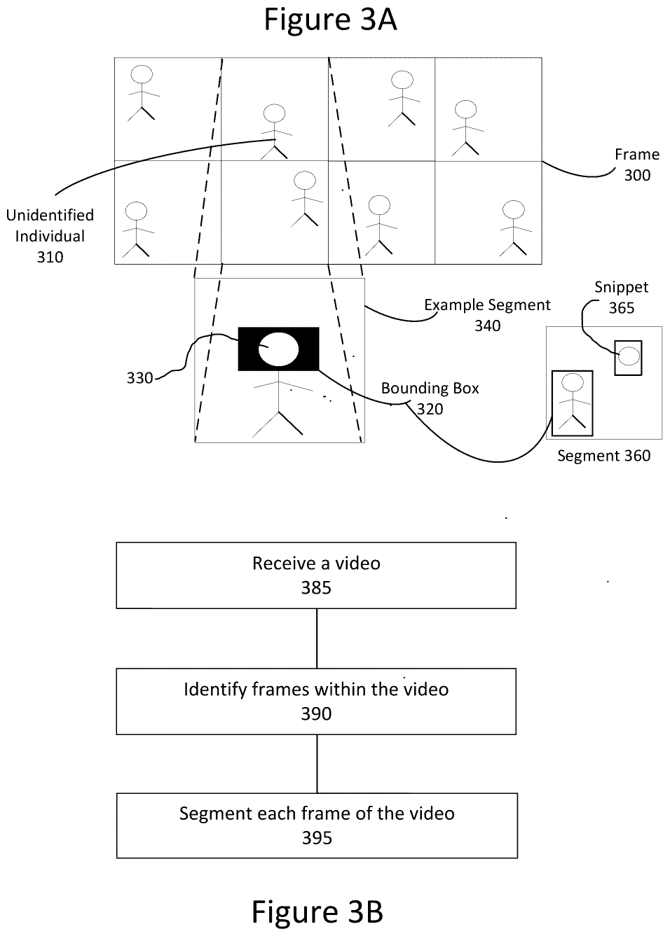

In this example, face detection of faces in the full motion video is performed as follows, where the video comprises a sequence of frames and each frame is essentially a still, or static, image or photograph. An object recognition algorithm, for example an SSD detection algorithm as discussed above, is trained on a wide variety of challenging samples for face detection. Using this approach, and with reference to FIGS. 3A-3C, an embodiment of the face detection method of the present invention processes a frame 300 and detects one or more unidentified individuals 310. The process thereupon produces a list of bounding boxes 320 surrounding faces 330. In an embodiment, the process also develops a detection confidence, and notes the temporal location in the video identifying the frame where each face was found. The spatial location within a given frame can also be noted.

To account for the potential presence of faces that appear small in the context of the entire frame, frames can be cropped into n images, or segments 340, and the face recognition algorithm is then run on each segment 340. The process is broadly defined by FIG. 3B, where a video is received at step 345, for example as a live feed from sensor 2000, and then divided into frames as shown at step 350. The frames are then segmented at step 355 into any convenient number of segments, where, for example, the number of segments can be selected based in part on the anticipated size of a face.

In some instances, the face detection algorithm may fail to detect a face because of small size or other inhibiting factors, but the object detector (discussed in greater detail below) identifies the entire person. In such an instance the object detector applies a bounding box around the entire body of that individual, as shown at 360 in FIG. 2A. For greater accuracy in such an instance, portions of a segment may be further isolated by selecting a snippet 365, comprising only the face. The face detection algorithm is then run on those snippets.

Again with reference to the system of FIG. 2C, in an embodiment object detection is performed using an SSD algorithm in a manner similar to that described above for faces. The object detector 230 can be trained on synthetic data generated by game engines. As with faces, the object detector produces a list of bounding boxes, the class of objects, a detection confidence metric, and a temporal location identifying the frame of video where the detected object was found.

In an embodiment, face recognition as performed by the recognition module 225, or the FRC module, uses a facial recognition algorithm, for example, the FaceNet algorithm, to convert a face snippet into an embedding which essentially captures the true identity of the face while remaining invariant to perturbations of the face arising from variables such as eye-glasses, facial hair, headwear, pose, illumination, facial expression, etc. The output of the face recognizer is, for example, a 128 dimension vector, given a face snippet as input. In at least some embodiments, during training the neural network is trained to classify all training identities. The ground truth classification has a “1” in the i^{th} coordinate for the i^{th} and 0 in all other coordinates. Other embodiments can use triplet loss or other techniques to train the neural network.

Training from face snippets can be performed by any of a number of different deep convolutional networks, for example Inception-Resnet V1 or similar, where residual connections are used in combination with an Inception network to improve accuracy and computational efficiency. Such an alternative process is shown in FIG. 4 where a face snippet 400 is processed using Inception-ResNet-V1, shown at 405, to develop an embedding vector 410. For detection and classification during training, the embedding 410 is then processed through a convolutional neural network having a fully connected layer, shown at 415, to develop a classification or feature vector 420. Rectangular bounding boxes containing a detected face are expanded along one axis to a square to avoid disproportionate faces and then scaled to the fixed size as discussed above. During recognition, only steps 400-405-410 are used. In an embodiment, classification performance is improved during training by generating several snippets of the same face.

The reasoning engine 240 (FIG. 2C) is, in an embodiment, configured to query the detection data produced by the face and object detectors and return results very fast. To this end, the reasoning engine employs a distributed processing system such as Apache Spark in a horizontally scalable way that enables rapid searching through large volumes, e.g. millions, of face embeddings and object detections. In an embodiment, queries involving identities and objects can be structured using Boolean expression. For specific identities, the cohort database is queried for sample embeddings matching the specified name. A designator such as a colon (“:”) allows identification of a class of objects rather than a person. Class terms, in the example “:car”, do not carry embeddings but instead are generic terms: any car matches “:car”. Similarly, any face in the data store will match “:face”. Specific examples of an item in a class can be identified if the network is trained to produce suitable embeddings for a given class of objects. As one example, a specific car (as identified e.g. by license plate), bag or phone could be part of the query if a network is trained to produce suitable embeddings for a given class.

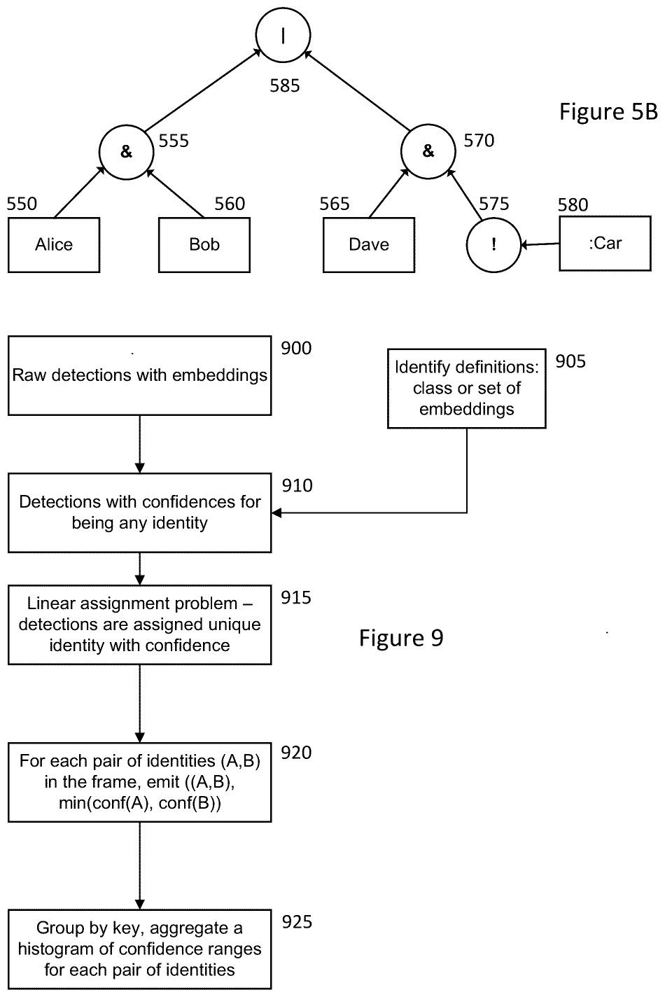

As noted above, in an embodiment the search data contains, in addition to the query string, the definitions of every literal appearing in the query. [It will be appreciated by those skilled in the art that a “literal” in this context means a value assigned to a constant variable.] Each token level detection, that is, each element in the query, is processed through a parse-tree of the query. For example, and as illustrated in FIG. 5A, the query “(Alice & Bob)|(Dave & !:car)”, shown at 500, will first be received by the REST API back-end 505, and will be split into operators to extract literals. Responsive embeddings in the data store or other memory location are identified at 515 and the response returned to the REST API. Embeddings set to null indicate that any car detection is of interest. Response to the class portion of the query is then added, resulting in the output seen at 520. The result is then forwarded to the SPARK-based search back-end 525.

The process of FIG. 5A is illustrated in Boolean form in FIG. 5B, where detections for each frame are evaluated against the literals in parse tree order, from bottom to top: Alice, Bob, Dave and :car. The query is first evaluated for instances in which both Alice (550) and (“&”, 555) Bob (560) are present, and also Dave (565) and (“&”, 570) any (“!”, 575) car (“:car”, 580) are present. The Boolean intersection of those results is determined at 585 for the final result. Detections can only match if they represent the same class.

If embeddings for the specific entities are provided, then a level of confidence in the accuracy of the match is determined by the shortest distance between the embedding for the detection in the video frame to any of the samples provided for the literal. It will be appreciated by those skilled in the art that ‘distance’ in context means vector distance, where both the embedding for the detected face and the embedding of the training sample are characterized as vectors, for example 128-bit vectors as discussed above. In an embodiment, an empirically derived formula can be used to map the distance into a confidence range of 0 to 1 or other suitable range. This empirical formula is typically tuned/trained so that the confidence metric is statistically meaningful for a given context. For example, the formula may be configured such that a set of matches with confidence 0.5 is expected to have 50% true matches. In other implementations, perhaps requiring that a more rigorous standard be met for a match to be deemed reliable, a confidence of 0.5 may indicate a higher percentage of true matches. Less stringent standards may also be implemented by adjusting the formula. It will be appreciated by those skilled in the art that the level of acceptable error varies with the application. In some cases it is possible to map the confidence to a probability that a given face matches a person of interest by the use of Bayes rule. In such cases the prior probability of the person of interest being present in the camera view may be known, for example, via news, or some other data. In such cases, the prior probability and the likelihood of a match can be used in Bayes rule to determine the probability that the given face matches the person of interest.

In an embodiment, for literals not carrying sample embeddings, the match confidence is simply the detection confidence. This should represent the likelihood that the detection actually represents the indicated class and again should be tuned to be statistically meaningful. As noted above, detections can only match if they are of the same class, so the confidence value for detections in different classes is zero. For all detections in the same class, there is a non-zero likelihood that any detection matches any identity. In other embodiments, such as those using geospatial imagery, objects may be detected in a superclass, such as “Vehicle”, but then classified in various subclasses, e.g, “Sedan”, “Convertible”, “Truck”, “Bus”, etc. In such cases, a probability/confidence metric might be associated with specific subclasses instead of the binary class assignment discussed above.

Referring to FIG. 6, an embodiment of a query process is shown from the expression of the query that begins the search until a final search result is achieved. The embodiment illustrated assumes that raw detections with embeddings have previously been accumulated, such as in Data Store 130 (FIG. 2B). Alternatively, the development of raw detections and embeddings can occur concurrently with the evaluation of the query. For purposes of simplicity and clarity, it is assumed that each identity can appear only once in any given frame. This is not always true, for example a single frame could include faces of identical siblings could, or a reflection in a mirror. Similarly, there can be numerous identical objects, such as “blue sedan”, in a single frame. However, in most instances, especially involving faces, the assumption will be true and, at least for many embodiments, the final truth value of the expression of the query is derived from the best possible instance. This permits the expression to be solved as a linear assignment problem where standard solvers, for example the Hungarian algorithm, can be used to yield a solution.

Thus, for FIG. 6, at step 600 a collection of raw detections (e.g., faces, objects, activities) with embeddings is made available for evaluation in accordance with a query 620 and query parse tree 625. Identity definitions, such as by class or set of embedding, are defined at step 605, and the raw detections are evaluated accordingly at step 610. The result is solved with any suitable linear assignment solver as discussed above, where detections are assigned unique identity with a confidence value, shown at 615. In some embodiments, for example those where it might be desirable to rigorously avoid false positives, a solution is a one-to-one assignment of literals to detections in the frame, which requires there to be exactly the same number of literals and detections in the frame. In other embodiments, a more relaxed implementation of the algorithm can yield better results. For example, if the query is (Alice & blue sedan)|(purple truck), it is useful to match “blue sedan” and “purple truck” literals to a single vehicle detection in the frame rather than forcing a linear assignment that prevents one or the other from matching at all. This enables a more considered evaluation of the truthfulness of (Alice & blue sedan|(purple truck). If, in the example, the probability of Alice is low, then even though the vehicle might be more blue than purple, and more sedan than truck, the evaluation of the final query would get a higher truth value as matching “purple truck”. Depending upon the nature of the literal, matching multiple literals to the same detection can be either allowed or disallowed. As one example, an embodiment can have all face detections matched one-to-one to named persons in the query, while all other detections allow many-to-many matching.

When this is not the case a priori, either dummy detections or literals can be introduced. These represent “not in frame” and “unknown detection”, respectively. A fixed confidence value, for example −1, can be assigned to any such detections. The linear assignment problem maximizes the sum of confidences of the assignments, constrained to one-to-one matches. In this case, it gives the maximum sum of confidences. Since there must be |#detections—#literals|assignments to dummy entries, there will be a fixed term in the cost, but the solution still yields the strongest possible assignment of the literals.

As noted above, steps 600 to 610 can occur well in advance of the remaining steps, such as by recording the data at one time, and performing the searches defined by the queries at some later time.

The total frame confidence is then evaluated through the query parse tree, step 630, using fuzzy-logic rules: a & b=>min(a,b), a|b=>max(a,b), !a=>1−a. Additionally, a specific detection box is associated to each literal. These boxes are propagated through the parse tree. Each internal node of the parse tree will represent a set of detection boxes. For “&”, it is the union of the detection boxes of the two children. For “|”, it is the set on the side that yields the maximum confidence. For “!” (not), it is an empty set, and may always be an empty set. In the end, this process yields, for each frame, a confidence value for the expression to match and a set of detection boxes that has triggered that confidence, 635.

For example, assume that the query asks “Are both Alice and Bob in a scene” in the gallery of images. The analysis returns a 90% confidence that Alice is in the scene, but only a 75% confidence that Bob is in the scene. Therefore, the confidence that both Bob and Alice are in the scene is the lesser of the confidence that either is in the scene—in this case, the 75% confidence that Bob is in the scene. Similarly, if the query asks “Is either Alice or Bob in the scene”, the confidence is the maximum of the confidence for either Alice or Bob, or 90% because there is a 90% confidence that Alice is in the scene. If the query asks “Is Alice not in the scene”, then the confidence is 100% minus the confidence that Alice is in the scene, or 10%.

The per-frame matches are pooled into segments of similar confidence and similar appearance of literals. Typically the same identities, e.g., “Alice & Bob”, will be seen in multiple consecutive frames, step 640. At some point, this might switch and while the expression still has a high confidence of being true, it is true because Dave appears in the frame, without any cars. When this happens, the first segment produces a separate search result from the second. Also, if there is empty space where the query is true with a much lower confidence, in an embodiment that result is left out or moved into a separate search result, and in either case may be discarded due to a low confidence value (e.g., score). As noted hereinabove, the term “segment” in this context refers to a sequence of video data, rather than parts of a single frame as used in FIGS. 3A-3B.

Finally, for each segment, the highest confidence frame is selected and the detection boxes for that frame are used to select a summary picture for the search result, 645. The segments are sorted by the highest confidence to produce a sorted search response of the analyzed video segments with thumbnails indicating why the expression is true, 650.

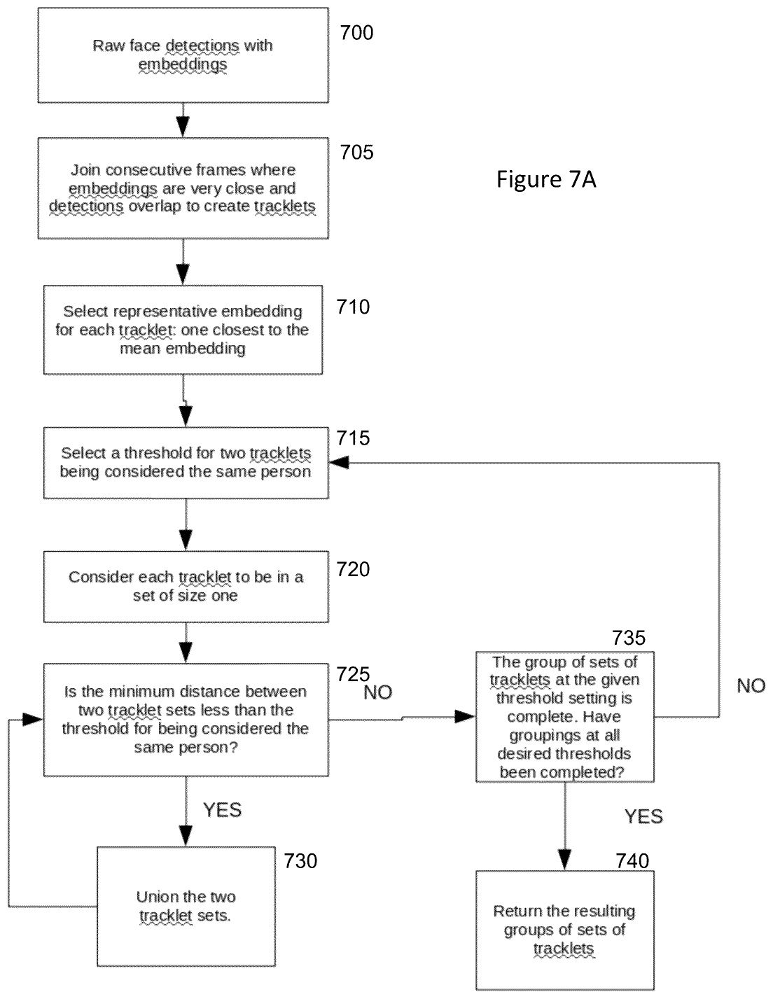

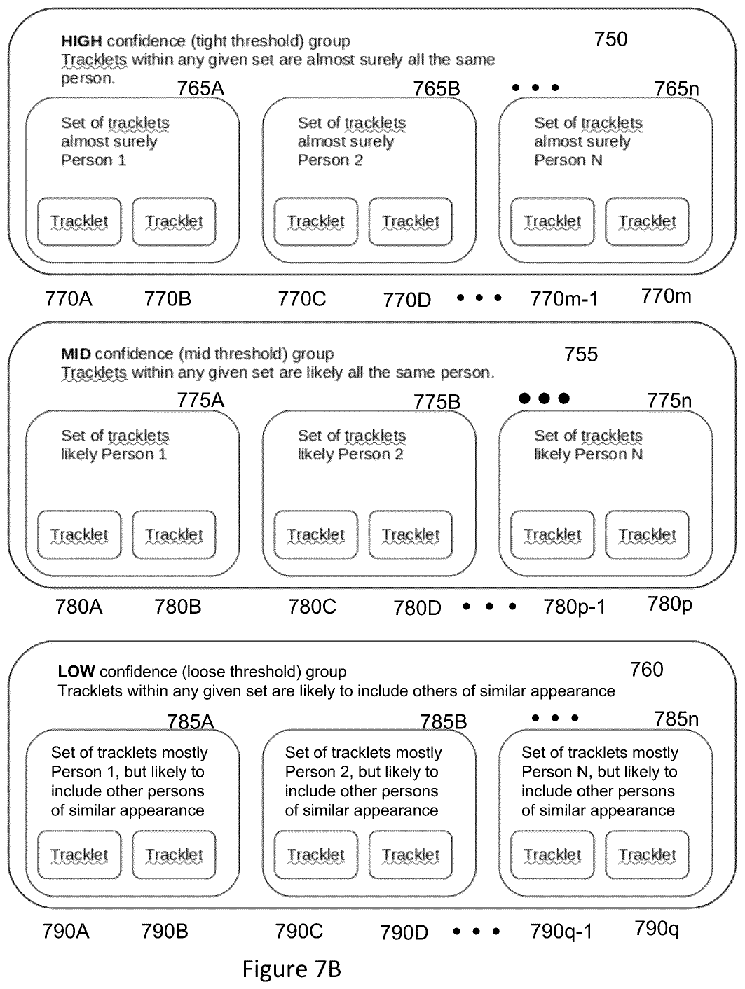

The foregoing discussion has addressed detecting movement through multiple frames based on a per-frame analysis together with a query evaluated using a parse tree. In an alternative embodiment, tracking movement through multiple frames can be achieved by clustering detections across a sequence of frames. The detection and location of a person of interest in a sequence of frames creates a tracklet (sometimes called a “streak” or a “track”) for that person (or object) through that sequence of data, in this example a sequence of frames of video footage. In such an embodiment, clusters of face identities can be discovered algorithmically as discussed below, and as illustrated in FIGS. 7A and 7B.

In an embodiment, the process can begin by retrieving raw face detections with embeddings, shown at 700, such as developed by the techniques discussed previously herein, or by the techniques described in the patent applications referred to in the first paragraph above, all of which are incorporated by reference in full. In some embodiments, and as shown at 705, tracklets are created by joining consecutive frames where the embeddings assigned to those frames are very close (i.e., the “distance” between the embeddings is within a predetermined threshold appropriate for the application) and the detections in those frames overlap. Next, at 710 a representative embedding is selected for each tracklet developed as a result of step 705. The criteria for selecting the representative embedding can be anything suitable to the application, for example, the embedding closest to the mean, or an embedding having a high confidence level, or one which detects an unusual characteristic of the person or object, or an embedding that captures particular invariant characteristics of the person or object, and so on.

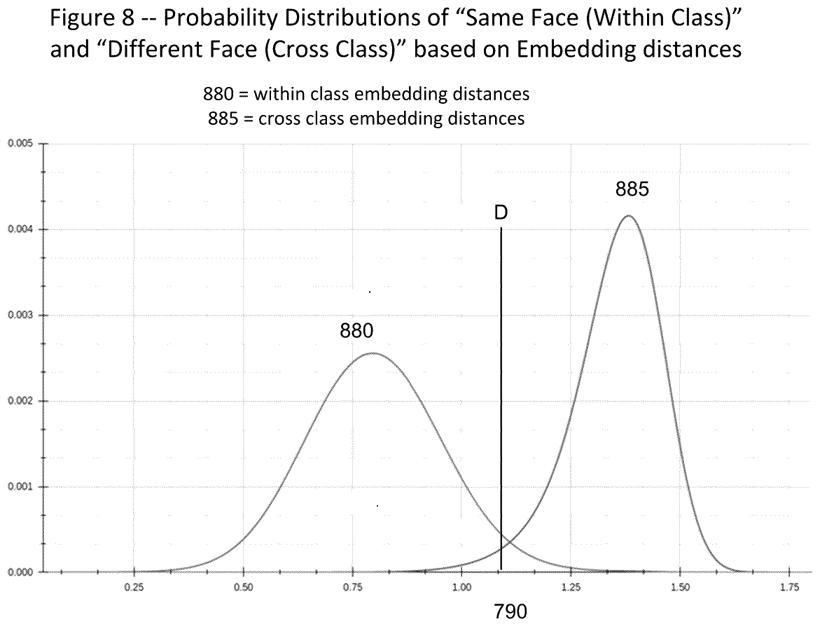

Next, as shown at 715, a threshold is selected for determining that two tracklets can be considered the same person. As discussed previously, and discussed further in connection with FIG. 8, the threshold for such a determination can be set differently for different applications of the invention. In general, every implementation has some probability of error, either due to misidentifying someone as a person of interest, or due to failing to identify the occurrence of a person of interest in a frame, The threshold set at step 715 reflects the balance that either a user or an automated system has assigned. Moreover, multiple iterations of the process can be performed, each at a different threshold such that groupings at different confidence levels can be presented to the user, as shown better in FIG. 7B. Then at step 720, each tracklet is considered to be in a set of tracklets of size one (that is, the tracklet by itself) and at 725 a determination is made whether the distance between the embeddings of two tracklet sets is less than the threshold for being considered the same person. If yes, the two tracklet sets are unioned as shown at 730 and the process loops to step 725 to consider further tracklets. If the result at 725 is no, then at 735 the group of sets of tracklets at a given threshold setting is complete and a determination is made whether additional groupings, for example at different thresholds, remain to be completed. If so, the process loops to step 715 and another threshold is retrieved or set and the process repeats. Eventually, the result at step 735 is “yes”, all groupings at all desired thresholds have been completed, at which time the process returns the resulting groups of sets of tracklets as shown at 740.

The result of the process of FIG. 7A can be better appreciated from FIG. 7B. In FIG. 7B, three groups 750, 755, 760 are shown, each representative of a different confidence level of detection. Thus, group 750 represents sets of tracklets where each set comprises one or more tracklets of an associated person or object. FIG. 7B shows sets 765A-765n of tracklets 770A-7770m for Person 1 through Person N to which the system has assigned a high level of confidence that each tracklet in the set is in fact the person identified. As illustrated, there is one set of tracklets per person, but, since the number of tracklets in any set can be more than one, sets 765A-765n can comprise, in total, tracklets 770A-770m.

Then, at 755 is shown a group of tracklets that have been assigned only a midlevel confidence value, that is, in sets 775A-775n, it is likely but not certain that each of the tracklets 780A-780p corresponds to the identified person or object. Finally, at 760 is a group of sets 785A-785n of tracklets 790A-790q where detection and filtering has been done only to a low confidence level, such as where only gross characteristics are important. Thus, while the tracklets 790A-790q are probably primarily associated with the person or object of interest, e.g., Person 1-PersonN, they are likely to include other persons of similar appearance or, in the case of objects, other objects of similar appearance. It will be appreciated that, in at least some embodiments, when the tracklets are displayed to a user, each tracklet will be depicted by the representative image for that tracklet, such that what the user sees is a set of representative images by means of which the user can quickly make further assessments.

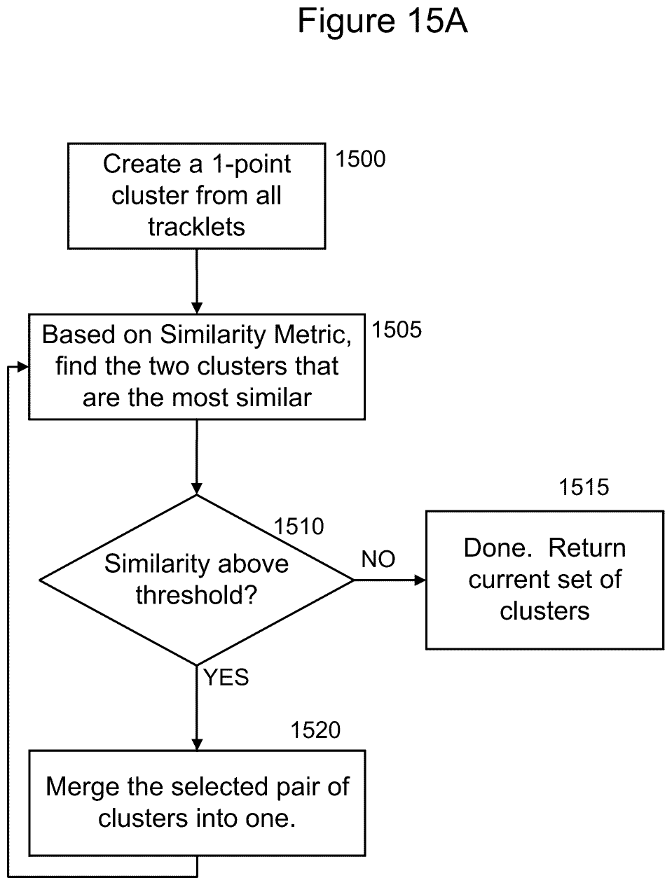

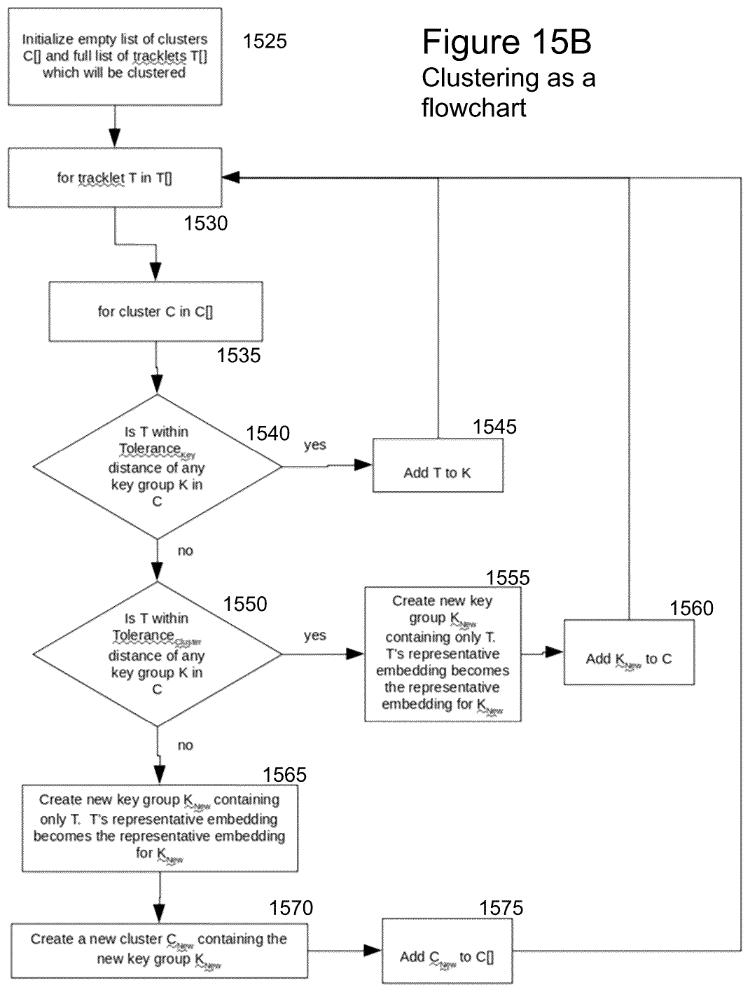

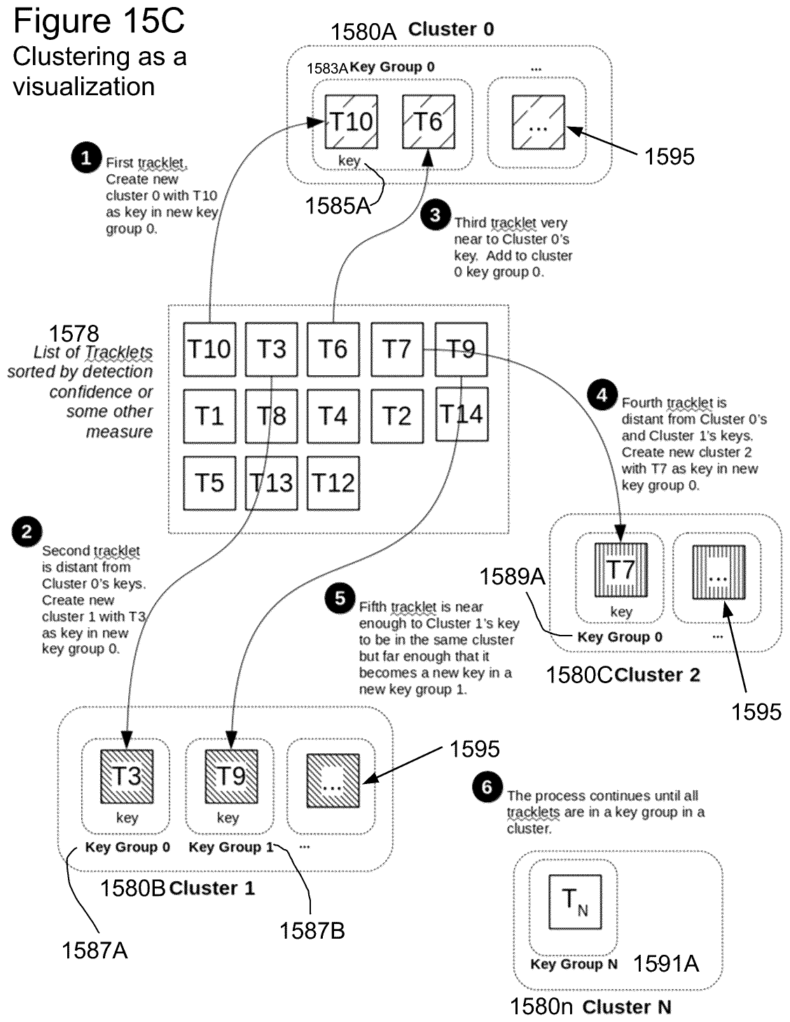

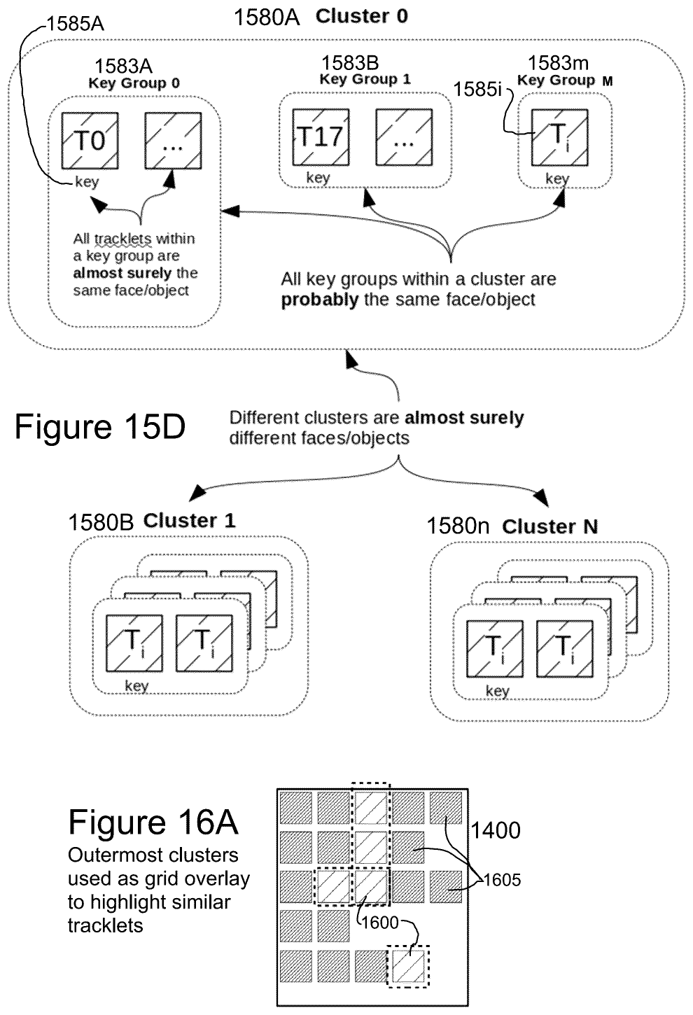

Referring next to FIG. 8, an important aspect of some embodiments of the invention can be better appreciated. As noted previously, in some applications of the present invention, greater accuracy or greater granularity is preferred at the expense of less compression of the data, whereas in other applications, greater compression of the data is preferred at the expense of reduced accuracy and reduced granularity. Stated differently, in some applications permitting missed recognitions of an object or person of interest may be preferred over false matches, i.e., wrongly identifying a match. In other applications, the opposite can be preferred. The probability distribution curves 880 and 885 of FIG. 8 illustrate this trade-off, in terms of choosing an optimal embedding distance that balances missed recognitions on the one hand and false matches on the other. In FIG. 8, curve 880 (the left, flatter curve) depicts “in class” embedding distances, while the curve 885 (the right curve with the higher peak) depicts cross class embedding distances. The vertical line D depicts the embedding distance threshold for a given application. The placement of vertical line D along the horizontal axis depicts the balance selected for a particular application. As an example, for the vertical line D indicated at 790, the area of curve 780 to the right of the line D represents the missed recognition probability while the area under the curve 785 to the left of the line D, 790, represents the false recognition probability. It will be appreciated by those skilled in the art that selection of that threshold or balance point can be implemented in a number of different ways within the systems of the present invention, including during training, at selection of thresholds as shown in FIG. 7A, or during clustering as discussed hereinafter in connection with FIGS. 15A-15D, or at other convenient steps in processing the data.

Referring next to FIG. 9, an aspect of the invention relating assigning a confidence value to a detection can be better appreciated. More specifically, FIG. 9 illustrates a novel capability to discover the strength of relationships between actors around a person of interest through analysis of the multisensor data. Assuming this is proportional to the amount of time people appear together in the same frame in the videos, the strength of the relationship between two detected faces or bodies can be automatically computed for every individual defined by sample embeddings.

Starting with retrieving raw detections with embeddings, shown at 900, and identity definitions, 905, every frame of the video is evaluated for presence of individuals in the same way as if searching for (A|B| . . . )—e.g. the appearance of any identity as discussed above. Every frame then produces a set of key value pairs, where the key is a pair of names, and the value is confidence, shown at 910 and 915. For example, if a frame is deemed to have detections of A, B and C, with confidences c_a, c_b, c_c, respectively, then three pairs exist: ((A,B),min(c_a,c_b)), ((A,C), min(c_a,c_c), ((B,C), min(c_b, c_c)) as shown at 920.

These tuples are then reduced (for example, in Spark, taking advantage of distributed computing) according to the associated key into histograms of confidences, shown at 925, with some bin size, e.g. 0.1 (producing 10 bins). In other words, for any pair of people seen together, the count of frames where they appear together at a given confidence range can be readily determined.

From this, the likelihood or strength of connection between the individuals can be inferred. Lots of high confidence appearances together indicate a high likelihood that the individuals are connected. However, this leaves an uncertainty: are ten detections at confidence 0.1 as strong a single detection at confidence 1.0? This can be resolved from the histogram data, by providing the result to an artificial intelligence algorithm or to an operator by means of an interactive tool and receiving as a further input the operator's assessment of the connections derived with different settings. As noted above, the level of acceptable error can vary with the particular application, as will the value/need for user involvement in the overall process. For example, one application of at least some aspects of the present invention relate to customer loyalty programs, for which no human review or intervention may be necessary.

For some detected individuals, the objective of searching for companions may be to find any possible connection, such as looking for unlikely accomplices. For example, certain shoplifting rings travel in groups but the individuals appear to operate independently. In such a case, a weaker signal based on lower confidence matches can be acceptable. For others, with many strong matches, higher confidence can be required to reduce noise. Such filtering can easily be done at interactive speeds, again using the histogram data.

Other aspects of the strength of a connection between two detected individuals are discussed in U.S. patent application Ser. No. 16/120,128 filed Aug. 31, 2018 and incorporated herein by reference. In addition, it may be the case that individuals within a network do not appear in the same video footage, but rather within a close time proximity of one another in the video. Other forms of connection, such as geospatial, with reference to a landmark, and so on, can also be used as a basis for evaluating connection. In such cases, same-footage co-incidence can be replaced with time proximity or other relevant co-incidence. Using time proximity as an example, if two persons are very close to each other in time proximity, their relationship strength would have a greater weight than two persons who are far apart in time proximity. In an embodiment, a threshold can be set beyond which the connection algorithm of this aspect of the present invention would conclude that the given two persons are too far apart in time proximity to be considered related.

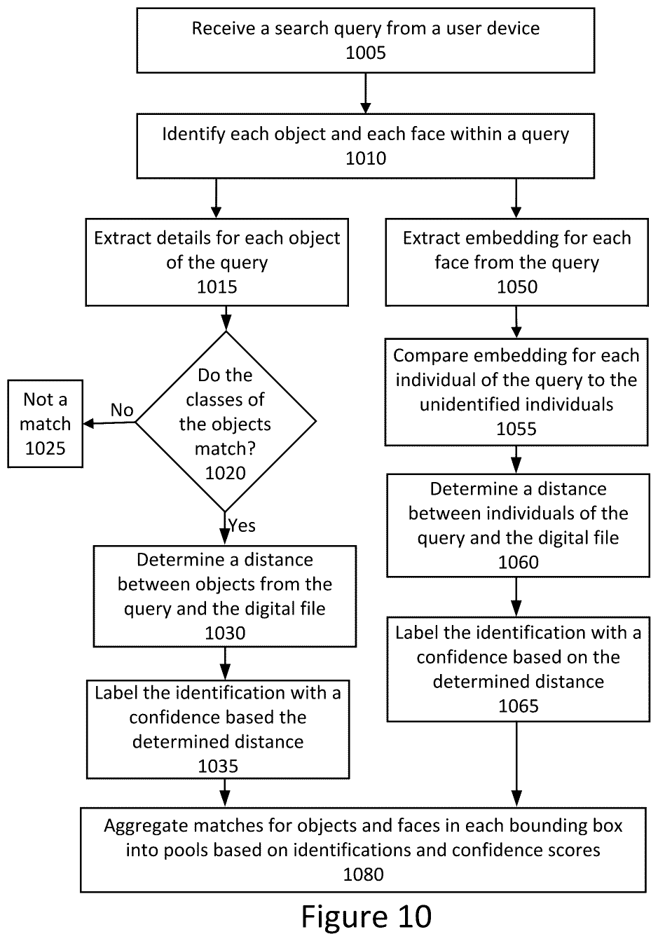

As noted earlier in the discussion of FIGS. 5A-5B et seq., in some embodiments the present invention can identify an entity, i.e., a person, in combination with a specific object. FIG. 10 shows an example flowchart describing the process for detecting matches between targets received from a query and individuals identified within a selected portion of video footage, according to an example embodiment. As described above, the techniques used to match target individuals to unidentified individuals within a sequence of video footage may also be applied to match target objects to unidentified objects within a sequence of video footage. At 1005 a search query is received from a user device and at 1010 each target object and each target individual within the query is identified. For each target object, at step 1015 the query processor extracts a feature vector from the query describing the physical properties of each object. The process then iteratively moves through frames of the digital file and the groupings derived therefrom to compare the feature vector of each target object to the feature vector of each unidentified object. Before comparing physical properties between the two feature vectors, the classes of the two objects are compared at step 1020. If the object classes do not match the process branches to step 1025 and the process advances to analyze the next unidentified object within the file. If the objects do match, the process advances to step 1030 where the feature distance is calculated between the query object and the object from the digital file. Finally, each match is labeled at step 1035 with a confidence score based on the determined distance of the feature vectors. The process then loops to examine any objects remaining for analysis.

Simultaneously following step 1010, embeddings are extracted at step 1050 for each face from the query. The embeddings of each individual in the query are then compared at step 1055 to the unidentified individuals in the data file. At step 1060 a feature distance is determined between the individuals in the query and the individuals identified from the digital file to identify matches. At step 1065 each match is labeled with a confidence based on the determined feature distance. Finally, the recognition module aggregates at step 1080 the matches detected for objects and faces in each grouping into pools pertaining to individual or combinations of search terms and organizes each of the aggregated groupings by confidence scores.

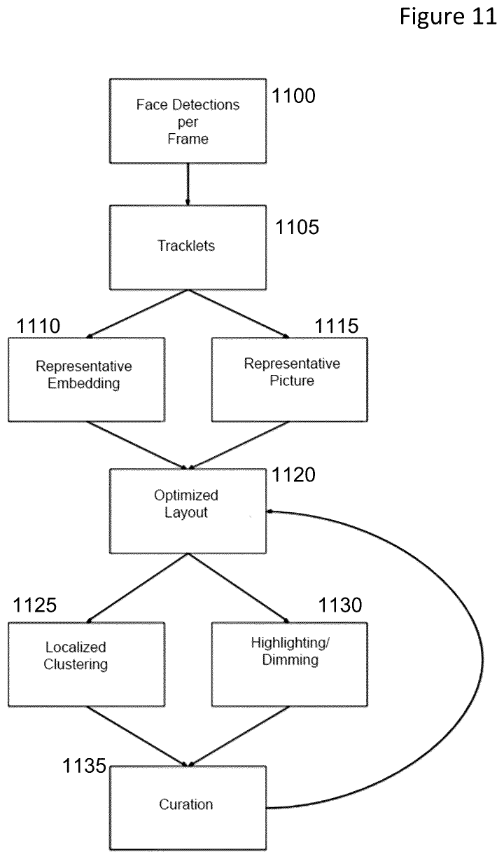

Referring next to FIG. 11, details of the second major aspect of the present invention can be better appreciated from the following. As summarized above, the second major aspect differs from the first in that the detections are made without the use of a probe or reference image, although both rely on the same basic multisensor processing platform. Fundamentally, the objective of this aspect of the invention is to simplify and accelerate the review of a large volume of sequential data such as video footage by an operator or appropriate algorithm, with the goal of identifying a person or persons of interest where the likeness of the those individuals is known only in a general way, without a photo. As will be appreciated from the following discussion, this goal is achieved by compressing the large volume of unstructured data into representative subsets of that data. In addition, in some embodiments, frames that reflect no movement relative to a prior frame are not processed and, in other embodiments, portions of a frame that show no movement relative to a prior frame are not processed.

This is accomplished by dividing the footage into a plurality of sequences of video frames, and then identifying all or at least some of the persons detected in a sequence of video frames. The facial detection system comprises a face detector and an embedding network. The face detector generates cropped bounding boxes around faces in any image. In some implementations, video data supplemented with the generated bounding boxes may be presented for review to an operator. As needed, the operator may review, remove random or false positive bounding boxes, add bounding boxes around missed faces, or a combination thereof. In an embodiment, the operator comprises an artificial intelligence algorithm rather than a human operator.

The facial images within each network are input to the embedding network to produce some feature vector, for example a 128-dimensional vector of unit length. The embedding network is trained to map facial images of the same individual to a common individual map, for example the same 128-dimension vector. Because of how deep neural networks are trained in embodiments where the training uses gradient descent, such an embedding network is a continuous and differentiable mapping from image space (e.g. 160×160×3 tensors) to, in this case, S127, i.e. the unit sphere embedded in 128 dimensional space. Accordingly, the difficulty of mapping all images of the same person to exactly the same point is a significant challenge experienced by conventional facial recognition systems. Additionally, conventional systems operate under the assumption that embeddings from images of the same person are closer to each other than to any embedding of a different person. However, in reality, there exists a small chance that embeddings of two different people are much closer than two embeddings of the same person, which conventional facial recognition systems fail to account for.

To overcome those limitations of conventional systems, the facial recognition system interprets images of the same person in consecutive frames as differing from each other much less than two random images of that person. Accordingly, given the continuity of the embedding mapping, the facial recognition system can reasonably expect embeddings to be assigned much stronger face detections between consecutive frames compared to the values assigned to two arbitrary pictures of the same person.

Still referring to FIG. 11, the overall process of an embodiment of this aspect of the invention starts at 1100 where face detections are performed for each frame of a selected set of frames, typically a continuous sequence although this aspect of the present invention can yield useful data from any sequence. The process advances to 1105 where tracklets are developed as discussed hereinabove. Then, at 1110 and 1115, a representative embedding and representative picture is developed. The process advances to laying out the images developed in the prior step, 1120, after which localized clustering is performed at step 1125 and highlighting and dimming is performed substantially concurrently at step 1130. Curation is then performed at step 1135, and the process loops back to step 1120 with the results of the newly curated data. Each of these general steps can be better appreciated from the following discussion. It will be appreciated that, in at least some embodiments, when the tracklets are displayed to a user, such as at the layout step, each tracklet will be depicted by the representative image or picture for that tracklet, such that what the user sees is a set of representative images by means of which the user can quickly make further assessments.

As touched on hereinabove, in at least some embodiments the system of the present invention can join face detections in video frames recorded overtime using the assumption that each face detection in the current frame must match at most one detection in the preceding frame. As noted previously, a tracklet refers to a representation or record of an individual or object throughout a sequence of video frames. The system may additionally assign a combination of priors/weights describing a likelihood that a given detection will not appear in the previous frame, for example based on the position of a face in the current frame. For example, in some implementations new faces may only appear from the edges of the frame. The facial recognition system may additionally account for missed detections and situations in which one or more faces may be briefly occluded by other moving objects/persons in the scene.

For each face detected in a video frame, the facial recognition system determines a confidence measure describing a likelihood that an individual in a current frame is an individual in a previous frame and a likelihood that the individual was not in the previous frame. For the sake of illustration, the description below describes a simplified scenario. However, it should be understood that the techniques described herein may be applied to video frames with much larger amounts of detections, for example detections on the order of tens, hundreds or thousands. In a current video frame, individuals X, Y, and Z are detected. In a previous frame, individuals A and B are detected. Given the increase in detections from the previous frame to the current frame, the system recognizes that at least one of X, Y, and Z were not in the previous frame at all, or at least were not detected in the previous frame. Accordingly, in one implementation, the facial recognition system approaches the assignment of detection A and B to two of detections X, Y, and Z using linear assignment techniques, for example the process illustrated below.

| | Detection X | Detection Y | Detection Z |
|---|---|---|---|
| Detection A | s(A, X) | s(A, Y) | s(A, Z) |
| Detection B | s(B, X) | s(B, Y) | s(B, Z) |
| Not In This Frame | k | k | k |

An objective function may be defined in terms of match confidences. In one embodiment, the objective function may be designed using the embedding distances given that smaller embedding distances correlate with a likelihood of being the same person. For example, if an embedding distance between detection X and detection A is less than an embedding distance between detection Y and detection A, the system recognizes that, in general, the individual in detection A is more likely to be the same individual as in detection X than the individual in detection Y. To maintain the embedding network, the system may be trained using additional training data, a calibration function, or a combination thereof.

In another embodiment, the probability distributions that define the embedding strength are

P(d(x,y)|Id(x)=Id(y))

and

P(d(x,y)|Id(x)≠Id(y)),

where d(x,y) is the embedding distance between two samples x,y and Id(x) is the identity (person) associated with sample x. These conditional probability distribution functions of the embedding distance are independent of the prior probability P(Id(x)=Id(y)), which is a critical feature of the validation data that would be reflected in typical Receiver Operating Characteristic (ROC) curves used to evaluate machine learning (ML) systems. However, these conditional probabilities can also be estimated using validation data, for example using validation data that represents sequences of faces from videos to be most representative of the actual scenario

Given the prior probability distribution p_{T}=P(Id(x)=Id(y)), the following can be defined:

$$s ( A , X ) = P ( Id ( A ) = I d ( X ) \vert d ( A , X ) ) = \frac{P ( d ( A , X ) \vert Id ( A ) = Id ( X ) ) {p}_{T}}{\begin{matrix}P ( d ( A , X ) \vert Id ( A ) = Id ( X ) ) {p}_{T} + \\ P ( d ( A , X ) \vert Id ( A ) \neq Id ( X ) ) ( 1 - {p}_{T} )\end{matrix}}$$

where the Bayes theorem is used to obtain the last equality. Further, it is natural to expect that k=1−p_{T}.

Continuing from the example scenario described above, the facial recognition system can estimate the probability distribution (p_{T}) from the number of detections in the current frame and the previous frame. If there are N detections (e.g., 3) in current frame and M (e.g., 2) in the previous frame, then the probability distribution may be modeled as

$${p}_{T} \approx \frac{min ( M , N )}{M N} - ε$$

where ε represents the adjustment made based on missed or incorrect detections.

In an embodiment, initially the active tracklets T are represented as an empty feature vector [ ]. In one embodiment, tracklet IDs are assigned to detections D in a new frame using the following process:
Define N=max(len(T), len(D))
Define p_{T}=(min(len(T), len(D))/(len(T)*len(D))−ε
Generate an N×N matrix D such that D(i,j)=s(D(i), To)) if i≤len(D) and j≤len(T) and 1−p_{T} otherwise
Based on the generated matrix, compute a one-to-one mapping f(i): [1,N]→[1,N] such that Σᵢ₌₁^{N} D(i, f(i)) is maximized.
For iϵ[1,N], assign a tracklet Id of T(f(i)) to detection i, if f(i)≤len(T). Otherwise generate a new tracklet ID for the detection.
Replace T with the detections from D with the assigned tracklet IDs.

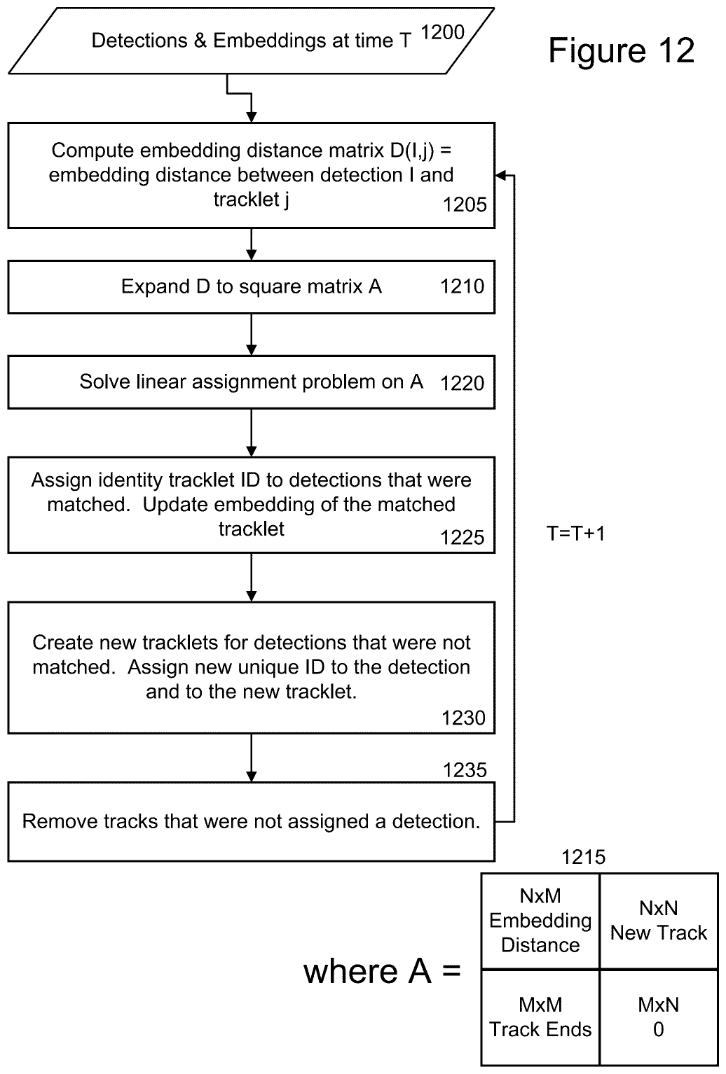

Referring next to FIG. 12, a technique for extracting tracklets in accordance with an embodiment of the invention can be better appreciated. Beginning at 1200, detections and embeddings at time T are retrieved. The embedding distance matrix D(l,j) is computed from the embedding distance between detection l and tracklet j, shown at 1205. Matrix D is then expanded into square matrix A, step 1210, where A is as shown at 1215 and discussed below, after which the linear assignment problem on A is solved, step 1220, to determine matches. For detections that were matched, an identity tracklet ID is either assigned or carried over from the matching detection in the preceding frame and the embedding of the matched tracklet is updated, 1225. New tracklets are created for detections that were not matched, 1230, with a new unique ID assigned to the detection and to the new tracklet. Finally, at step 1235, remove tracklets that were not assigned a detection. The process then loops back to step 1205 for the next computation.

As will be appreciated by those skilled in the art, for N detections and M active tracks, D is an N×M matrix. The matrix A will be (N+M)×(N+M) square matrix. The linear assignment problem is understood to produce a permutation P of [1, . . . , N+M] such that the sum over A[i, P(i)] for i=1 . . . N+M is minimized. The padded regions simply represent detections that represent identities that appear, identities that disappeared or are simply computational overhead as depicted on the right. Constant values are used for these regions and they represent the minimum distance required for a match. The linear assignment problem can be solved using standard, well known algorithms such as the Hungarian Algorithm.

To improve run time, a greedy algorithm can be used to find a “good enough” solution, which for the purposes of tracking is often just as good as the optimal. The greedy algorithm simply matches the pair (i,j) corresponding to minimum A(i,j) and removes row i and column j from consideration and repeats until every row is matched with something.

Tracks will have their representative embedding taken from the detection upon creation. A number of update rules can be used to match embeddings to tracks, including using an average of the embeddings assigned to the track. Alternatives include storing multiple samples for each track, or using a form of k-nearest distance to produce a meaningful sample-based machine learning solution. RANSAC or other form of outlier detection can be used in the update logic.

For each tracklet, the facial recognition system constructs a single embedding vector to represent the entire tracklet, hereafter referred to as a representative embedding. In one embodiment, the representative embedding is generated by averaging the embeddings associated with every detection in the tracklet. In another implementation, the facial recognition system determines a weighted average of the embeddings from every detection in the tracklet, where each of the weights represent an estimate of the quality and usefulness of the sample for constructing an embedding which may be used for recognition. The weight may be determined using any one or more combination of applicable techniques, for example using a Long Short-term Recurrent Memory (LSTM) network trained to estimate weights that produce optimized aggregates.

In another embodiment, the facial recognition system generates a model by defining a distance threshold in the embedding space and selecting a single embedding for the tracklet that has the largest number of embeddings within the threshold. In other embodiments, for example those in which multiple embeddings are within the distance threshold, the system generates a final representative embedding by averaging all embeddings within the threshold.

For purposes of illustration, in an embodiment a representative embedding is determined using the following process:
Define max_count=0
For e embeddings for the tracklet
Define cnt=count (d(e,x)<th for x in embeddings)−1
If cnt>max_count:
   Define max_count=cnt
   Define center=e
Determine the output as:
   avg(x for x in embeddings if d(x,center)<th)

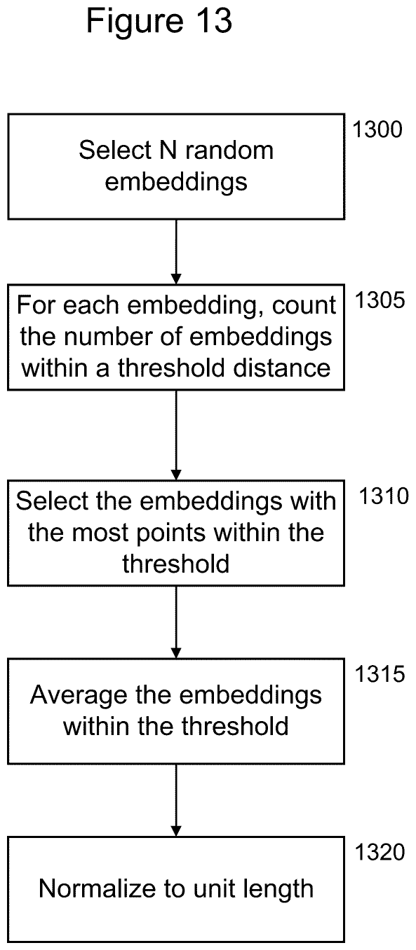

With reference to FIG. 13, a process for selecting a representative embedding is illustrated in flow diagram form. Beginning at step 1300, the process initiates by selecting N random embeddings. Then, at 1305, for each embedding, a count is made of the number of other embeddings within a predetermined threshold distance. The embedding with the highest count is selected, 1310, and at 1315 an average is calculated of the embeddings within the threshold. The result is normalized to unit length and selected as the representative embedding, 1320.

Selection of a representative picture, or thumbnail, for each tracklet can be made in a number of ways. One exemplary approach is to select the thumbnail based on the embedding that is closest to the representative embedding, although other approaches can include using weighted values, identification of a unique characteristic, or any other suitable technique.

Once a representative picture and representative embedding have been selected, an optimized layout can be developed, per step 1120 of FIG. 11. In an embodiment, for each face detected in a sequence of video frames, the facial recognition system generates a tracklet with a thumbnail image of the individual's face, a representative embedding, and a time range during which the tracklet was recorded. In such an embodiment, the facial recognition system thereafter generates an interface for presentation to a user or AI system by organizing the group of tracklets based on the time during which the tracklet was recorded and the similarity of the tracklet embedding to the representative embedding.

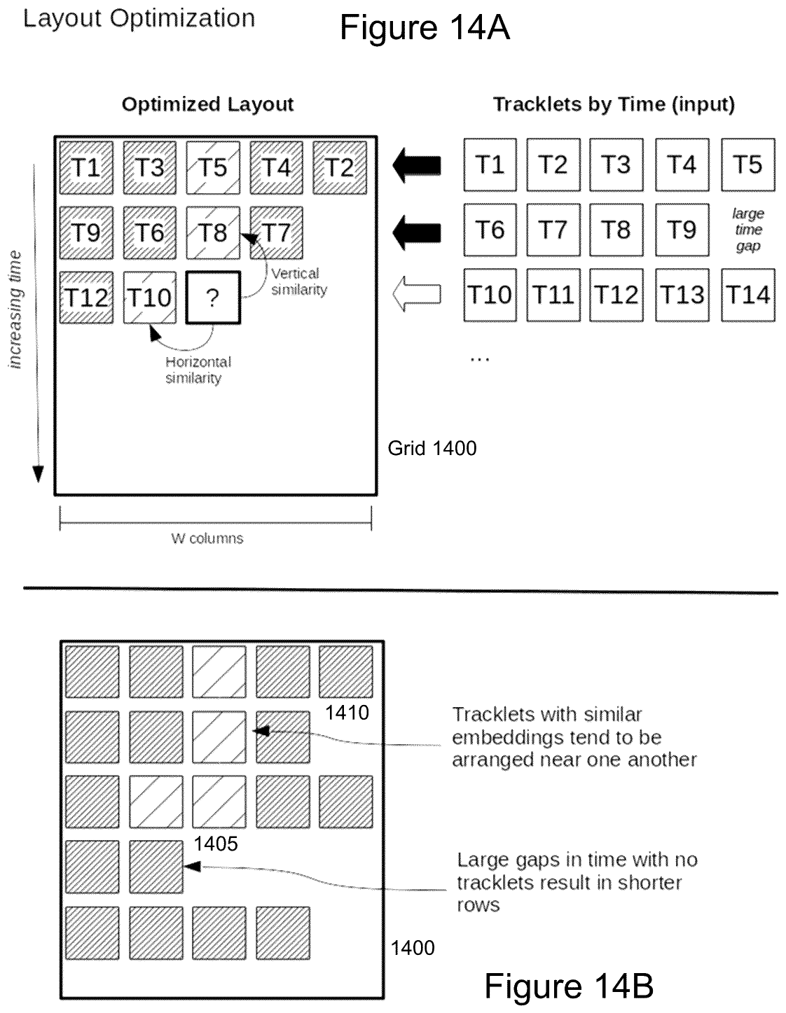

The results of such an approach can be appreciated from FIGS. 14A-14B. In the embodiment illustrated there, the vertical axis of the interface is designated as the time axis. Accordingly, scrolling down and up is equivalent to moving forward and back in time, respectively. By vertically scrolling through an entire interface of tracklets, shown as T1 to T10 arranged on grid 1400, a user can inspect the entirety of the footage of video data. Reviewing the tracklets by scrolling through the interface vertically may provide a user with a sense of progress as you scroll down the grid.

Additionally, each tracklet is positioned on the interface such that a first occurrence of a person may never be earlier to any appearing tracklet positioned higher on the interface.

Based on a fixed width of the display, a number of tracklets W can be displayed along the horizontal rows of the interface where the number W is defined as W=window_width/(thumbnail_width+padding). Images on the same row may be displayed in arbitrary order. Accordingly, in an embodiment designed to facilitate quick visual scanning, images can be ordered based on similarity using the following algorithm.

Given a list of tracklets T, sorted by their start time:
let P=[ ]
let S=T[:W], and T=T[W:], i.e. S is the first W tracklets taken out of T
If P is not empty, set N[0] to the tracklet in S closest to P[0] in embedding, otherwise N[0]=S[0]
Remove N[0] from S
For i in range(1, W):
   Find the element j in S such that d(S[j], N[i−1])+d(S[j], P[j]) is minimized where the latter term is zero if there is no element P[j] available.
   N[i]=S[j]
   Remove element j from S
add row N to the grid.
P=N
if T is not empty, goto 2

The foregoing algorithm attempts to minimize embedding distance between adjacent face pictures, such as shown at 1405 and 1410 of FIG. 14B. Accordingly, individuals with similar facial features, for example glasses or a beard, may be clustered together. In another implementation, the system may generate a globally optimal arrangement.

It may be the case that the same face appears multiple times within a layout such as shown in FIGS. 14A-14B, where tracklets T1-T14 represent a chronology of captured images intended for layout in a grid 1400. Even within a small section of video, the same face/object may appear in multiple distinct tracklets. This could be due to a number of reasons, such as occlusions that interrupted the continuity of the face/object from one frame to the next, the face/object exiting then re-entering the frame, or the inner workings of neural networks whereby two faces/objects which are the same to the human observer are not recognized as such by the system based on their embeddings. Because many people's faces look somewhat different depending upon the camera angle at which a person's image is captured, or the lighting conditions, or other physical or environmental factors, it is possible for images of the face of a single person to be categorized by the present invention as several different faces, and to have tracklets developed for each of those faces. In the present invention, those different perspectives of the same person are referred to as “key faces”. In an embodiment, tracklets with similar embeddings, e.g. 1405, can be arranged near one another while those that are dissimilar, e.g. 1410, are placed at the outer portions of the layout. As noted above, while the tracklets shown are depicted as shaded squares, in some embodiments each tracklet presented for review by a user will display the representative image or picture for that tracklet.

Combining tracklets that are of the same person effectively reduces, or compresses, the volume of data a user must go through when seeking to identify one or more persons from the throng of people whose images can be captured in even just a few minutes of video taken at a busy location. To aid in identifying cases where two or more tracklets are in fact the same face/object and thus enable further compression of the number of distinct data points that the user must review, the system may employ clustering, and particularly agglomerative clustering.

In simplified terms, agglomerative clustering begins with each tracklet being a separate cluster. The two closest clusters are iteratively merged, until the smallest distance between clusters reaches some threshold. Such clustering may take several forms, one of which can be a layer of chronologically localized clustering. One algorithm to achieve such clustering is as follows:
Given a list of tracklets T for a small section of footage (e.g. 5-10 minutes) ordered by confidence descending:
   let C=[ ]
   For i in range(0, T):
      let t=T[i]
      Calculate the distance D between t and c for
      each cluster c in C as follows:
         For k in c where k is a “key face” tracklet
         which is part of the cluster:
         Calculate the distance between t and k
         Return the minimum distance
      If D<same-cluster tolerance:
         Add tracklet t to cluster c and re-compute “key faces” (see below)
      Otherwise:
         Create a new cluster c, add tracklet t to it as a key face, and add c to C
Key face algorithm for tracklets t in cluster c
   let K=[ ]
   Fort in range(1, c): (2)
      For key face tracklet k in K:
         Calculate the distance D between t and k
         If D<same-key face tolerance, goto (2)
         Otherwise add t to K

The narrower the band of time, the more performant such a clustering algorithm will be. This can be tuned depending on how many faces are displayed in the grid at any given time such that the faces within the current frame of view are covered by the clustering algorithm. The results of such a clustering algorithm are embodied visually in the grid 1400. As shown there, in an embodiment, when one of the faces is selected (either by clicking or by hovering), all faces within the same cluster are highlighted within the grid. There is no guarantee that all faces within the cluster are indeed the same person, so this is an aid to the user and not a substitute for their own review and discretion.

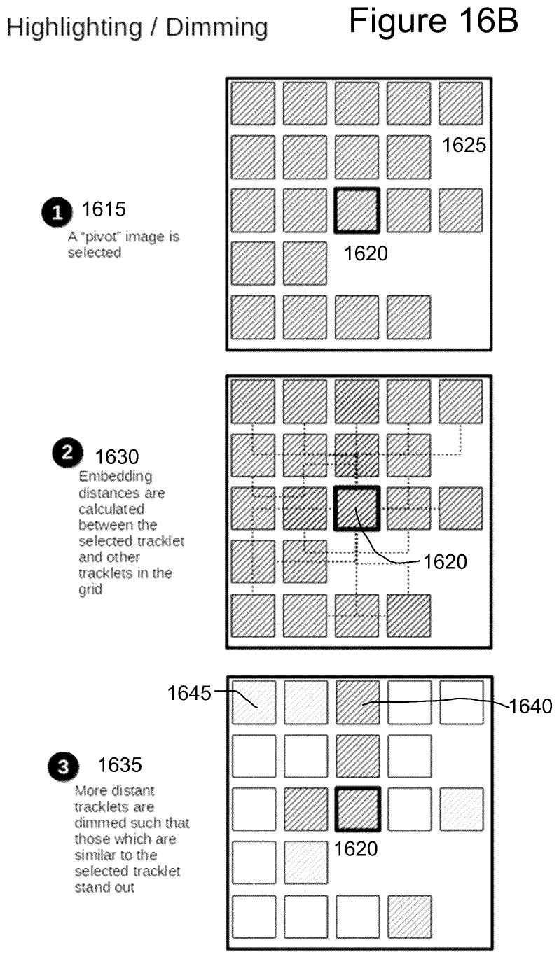

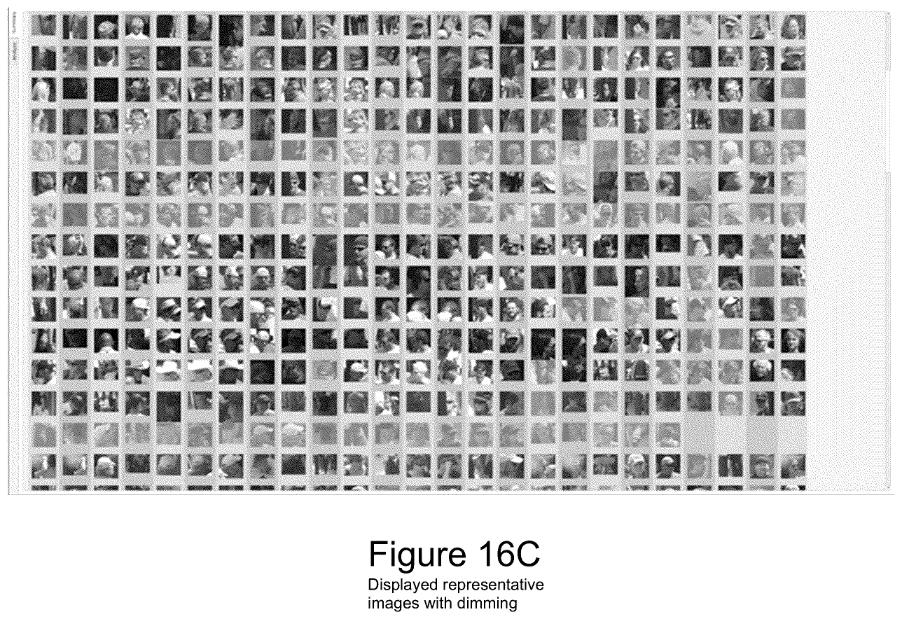

To elaborate on the foregoing, it will be appreciated by those skilled in the art that a distance between two clusters can be defined in various ways, such as Manhattan, Euclidean, and so on, which may give somewhat different results. The choice of how distance is defined for a particular embodiment depends primarily on the nature of the embedding. One common choice for distance is set distance. In at least some embodiments of the present invention, averaging the embedding works well and is recognized in the literature. Further, various methods of outlier removal can be used to select a subset of embeddings to include in computing the average. One approach, used in some embodiments is to exhaustively test, or randomly (RASNAC-like) select points and find how many other points are within some threshold of that point. The point that has the largest number of neighbors by this rule is selected as the “pivot” (see FIG. 16) and all the points within threshold of the pivot are then averaged, with points beyond the threshold being discarded as outliers.

FIG. 15A illustrates a simplified representation of localized clustering. Thus, at 1500, a single point cluster is created from all tracklets under consideration. Then, at 1505, using a similarity metric, a search is made for the two clusters that are the most similar. At 1510, the similarity of the two clusters is compared to a predetermined threshold. If the similarity is sufficiently high that it exceeds the threshold value, the two clusters are merged (agglomerated) at 1520. Conversely, if similarity between the two clusters is less than the threshold, the process is done and the current set of clusters is returned. It will be understood that, because the threshold can be varied, in accordance with the probability distribution curves discussed at FIG. 8, more or less merging of clusters will occur depending upon how the balance between the level of granularity of result and the level of data compression desired for a particular embodiment, and a particular application.

Referring next to FIGS. 15B-15D, a more detailed exposition of clustering in accordance with some embodiments of the present invention can be appreciated. As discussed above, clustering could be for the entire video or for a small section. For greater performance, it might be applied only to a narrow band of time in the video corresponding to what the system is currently reporting to the user in the aforementioned grid. If the goal is to more comprehensively analyze the entire video, then clustering could be applied to all tracklets or at least larger sections of the video.

Further, clustering can be hierarchical. Outertiers in the hierarchy yield the most compression and least accuracy, i.e., the highest likelihood that two tracklets that represent different underlying faces/objects are erroneously grouped together in the same cluster. Inner tiers yield the least compression but the most accuracy. One such hierarchical embodiment comprises three tiers as follows, and as depicted in FIGS. 15C and 15D:

Outer Tier (Cluster), 1580A-1580n: Each cluster C contains multiple key groups K. Key groups within a cluster are probably the same face/object. Different clusters C are almost surely different faces/objects.

Middle Tier (Key Group), 1585A (in Cluster 0), 1587A-1587B (in Cluster 1), 1589A (in Cluster 2), and 1591A (in Cluster N): A key group is simply a group of tracklets where the group itself has a representative embedding. In its simplest form, the group's representative embedding is the same as the representative embedding of the first tracklet added to the group. Tracklets within the key group are almost surely the same face/object. In an embodiment, when a key group is presented to a user, the key face is displayed as representative of that key group.

Inner Tier (Tracklet), T1-Tm: Each tracklet T is as described previously. Detections within a tracklet are substantially certain to be the same face/object.

One algorithm to generate such a hierarchical set of clusters is shown in flow chart form in FIG. 15B, and is further described as follows with reference numerals as indicated, with the first four steps below being collectively designated at 1525 on FIG. 15B:
Let C[ ] be an empty set of clusters representing the outermost tier
Let Tolerance_{Cluster} be the tolerance threshold for determining when two key groups belong in the same cluster
Let Tolerance_{Key} be the tolerance threshold for determining when two tracklets belong in the same key group
Given a list of tracklets T[ ]
For each tracklet Tᵢ: (1530)
   For each cluster Cᵢ in C[ ]:
      For each key group Kᵢ in Cᵢ: (1540)
         Calculate the vector distance Dᵢ between the representative embedding of Tᵢ and the representative embedding of the key tracklet in Kᵢ
      If Dᵢ<Tolerance_{Key} then add Tᵢ to the key group Kᵢ and continue with the next tracklet T in step (1530) (1545)
   If min(D₁₋ₙ)<Tolerance_{Cluster}:
      Create a new key group K with tracklet Tᵢ as the key tracklet and add K to Cᵢ then continue with the next tracklet T in step (1530) (1560)
T was not within tolerance of any given cluster C, so create a new key group K with T as the key tracklet, add to a new cluster C, and add C to the list of all outer clusters C[ ] and continue with next tracklet T in step (1530) (1565-1575)

To assist in understanding, the foregoing process can be visualized with reference to FIG. 15C. A group of tracklets T1-Tn, indicated collectively at 1578, is available for clustering. Each cluster, indicated at 1581A-n and captioned Cluster 0 through Cluster n, comprises one or more key groups, indicated at 1580A-n and captioned Key Group 0 through Key Group n. Through the process discussed above and shown in FIG. 15B, each tracklet is assigned to a Key Group, such as key group 1583A of Cluster 1580A. Each Cluster may have more than one Key Group, and the first tracklet assigned to each Key Group is the key tracklet for that group, as indicated at 1585A in Cluster 0. Each Key Group can have more than one tracklet. Embedding distance, calculated by any approach suitable to the application, is used to determine which key group a particular tracklet is assigned to.

In the example shown, the first tracklet, selected randomly or by any other convenient criteria and in this case T10, is assigned to Cluster 0, indicated at 1580A, and more specifically is assigned as the key tracklet 1585A in Cluster 0's Key Group 0, indicated at 1583A. The embedding of a second tracklet, T3, is distant from Cluster 0's key (i.e., the embedding of T10), and so T3 is assigned to Cluster 1, indicated at 1580B. As with tracklet T10, T3 is the first tracklet assigned to Cluster 1 and so becomes the key of Cluster 1's key group 0, indicated at 1587A. A third tracklet, T6, has an embedding very near to the embedding of T10—i.e., the key for key group 0 of Cluster 0—and so joins T10 in key group 0 of Cluster 0. A fourth tracklet, T7, has an embedding distance that is far from the key of either Cluster 0 or Cluster 1. As a result, T7 is assigned to be the key for Key Group 0 of Cluster 2, indicated at 1589A and 1580C, respectively. A fifth tracklet, T9, has an embedding distance near enough to Cluster 1's key, T3, that it is assigned to the same Cluster, or 1580B, but is also sufficiently different from T3's embedding that it is assigned to be the key for a new key group in Cluster 1's Key Group 1 indicated at 1587B. Successive tracklets are assigned as determined by their embeddings, such that eventually all tracklets, ending with tracklet Tn, shown assigned to Key Group N, indicated at 1591A of Cluster N, indicated at 1580n, are assigned to a cluster and key group. At that time, spaces 1595, allocated for tracklets, are either filled or no longer needed.

The end result of the processes discussed above and shown in FIGS. 15B and 15C can be seen in FIG. 15D, where each tier—Group of Clusters, Cluster, Key Group—can involve a different levels of granularity or certainty. Thus, each cluster typically has collected images of someone different from each other cluster. For example, Cluster 0 may have collected images that are probably of Bob but almost certainly not of either Mike or Charles, while Cluster 1 may have collected images of Mike but almost certainly not of either Bob or Charles, and Cluster N may have collected images of Charles but almost certainly not of either Bob or Mike. That's the first tier.

Then, within a given cluster, for example Cluster 0, while all of the images are probably of Bob, it remains possible that one or more key groups in Cluster 0 has instead collected images of Bob's doppelganger, Bob2, such that Key Group 1 of Cluster 0 has collected images of Bob2. That is the second tier of granularity.

The key group is the third level of granularity. Within a key group, for example Key Group 0 in Cluster 0, every tracklet within that Key Group 0 almost surely comprises images of Bob and not Bob2 nor anyone else. In this manner, each cluster represents a general area of the embedding space with several centers of mass inside that area. Using keys within each cluster reduces computational cost since it allows the system to compare a given tracklet with only the keys in a cluster rather than every tracklet in that cluster. It also produces the helpful side-effect of a few representative tracklets for each cluster. Note that, while three tiers of granularity have been used for purposes of example, the approach can be extended to N tiers, with different decisions and actions taken at each different tier. This flexibility is achieved in at least some embodiments through the configuration of various tolerances.

More specifically, and referring to steps 1540 and 1550 of FIG. 15B, the settings of Tolerance_{key} and Tolerance_{cluster} are used in at least some embodiments to configure the system to achieve a balance between data compression and search accuracy at each tier. This approach is an efficient variant of agglomerative clustering based on the use of preset fixed distance thresholds to determine whether a tracklet belongs in a given cluster and, further, whether a tracklet constitutes a new key within that cluster. As discussed above, each unassigned tracklet is compared to every key within a given existing cluster. The minimum distance of those comparisons is compared against Tolerance_{key}. If that minimum distance is less than or equal to Tolerance_{key}, then that tracklet is assigned to that key group within that cluster. If the minimum distance is greater than Tolerance_{key} for every key group within a cluster, but smaller than or equal to Tolerance_{cluster} for that cluster, then the unassigned tracklet is designated a key for a new key group within that cluster. If, however, the minimum distance for that unassigned tracklet is greater than Tolerance_{cluster} then the unassigned tracklet is not assigned to that cluster and instead is compared to the keys in the next cluster, and so on. If that unassigned tracklet remains unassigned after being compared with all existing clusters, either a new cluster (cluster N, step 1575 of FIG. 15B) is defined or, in some embodiments, the unassigned cluster is rejected as an outlier.

Such a hierarchy allows for different degrees of automated decision making by the system depending on how trustworthy and accurate the clustering is at each tier. It also allows the system to report varying degrees of compressed data to the user. At outer tiers, the data is more highly compressed and thus a user can review larger sections of data more quickly. The trade off, of course, is the chance that the system has erroneously grouped two different persons/objects into the same cluster and thus has obfuscated from the user unique persons/objects. The desired balance between compression of data, allowing more rapid review of large amounts of data, versus the potential loss of granularity is different for different applications and implementations and the present invention permits adjustment based on the requirements of each application.

As noted initially, there are two main aspects to the present invention. In some applications, an embodiment which combines both aspects can be desirable. Those skilled in the art will recognize that the first aspect, discussed above, uses a per-frame analysis followed by aggregation into groups. The per-frame approach to performing a search has the advantage that it naturally segments to a query in the sense that a complex query, particularly those with OR terms, can match in multiple ways simultaneously. As objects and identities enter and leave the scene—or their confidences change due to view point—the “best” reason to think the frame matched the query may change. It can be beneficial to split results so that these alternative interpretations of the data can be shown. The second main aspect of the invention, involving the use of tracklets, allows for more pre-processing of the data. This has advantages where no probe image exists although this also means that detections of objects are effectively collapsed in time up front.

In at least some embodiments of the invention, the system can combine clustering with the aforementioned optimized layout of tracklets as an overlay layer or other highlighting or dimming approach, as illustrated in FIGS. 16A-16C. As before, for some embodiments, while the tracklets in the grid 1400 are shown in the figures as shaded squares, when displayed to a user the tracklets will display the representative image for that tracklet. This can be appreciated from FIG. 16C, which shows how data in accordance with the invention may actually be displayed to a user, including giving a better sense of how many representative images might be displayed at one time in some embodiments.

Thus, to provide a visual aid to the user, all tracklets within a given cluster, e.g. tracklets 1600 can be highlighted or outlined together and differently than tracklets of other clusters, e.g. tracklets 1605, to serve to allow a human user to easily associate groups of representative faces/objects and thus more quickly review the data presented to them. Alternatively, the less interesting tracklets can be dimmed or blanked. The system in this sense would emphasize its most accurate data at the most granular tier (tracklets) while using the outermost tier (clusters) in an indicative manner to expedite the user's manual review.

Referring particularly to FIG. 16B, a process for selecting tracklets for dimming or highlighting can be better appreciated. At 1615, a “pivot” tracklet 1620 with its representative image is selected from a group of tracklets 1625 in the grid 1400. At 1630, embedding distances are calculated between the pivot tracklet and the other tracklets in the grid. Then, at 1635, tracklets determined to have an embedding distance less than a threshold, indicated at 1640, are maintained while tracklets determined to have an embedding distance greater than a threshold, indicated at 1645, are dimmed.

To further aid the visualization and readability of the generated interface, the facial recognition system may dim certain faces on the interface based on anticipated features of the suspect, as shown in FIG. 16C. When only an embedding is available, selecting (by clicking on them) similar looking faces may yield a set of close matches. For example, other samples in the grid that are close to this set can be highlighted making it easier to visually spot more similar faces. This implementation is illustrated in the following illustrated interface.

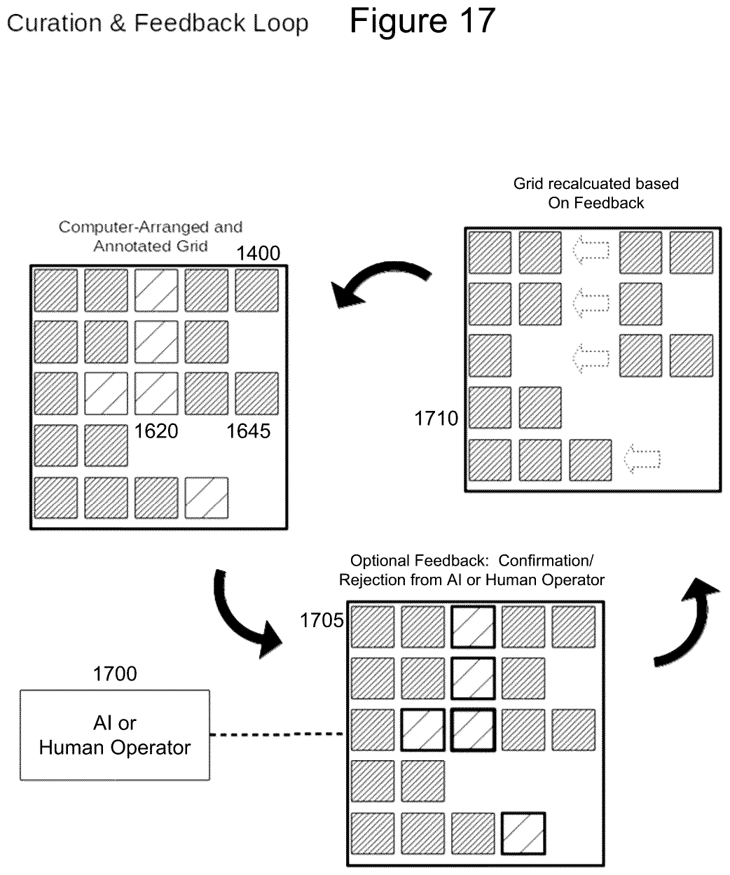

As a further aid to the user, a curation and feedback process can be provided, as shown in FIG. 17. Using the aforementioned visual aids, a human operator 1700 can identify sets of faces within the grid 1400 which they can confirm are the same person, e.g. as shown at 1705. Selecting a set of faces (e.g., by clicking) enables extraction of those faces from the grid as a curated person of interest, whereupon the grid re-adjusts as shown at 1710. In an embodiment, rows in the grid where faces were extracted are reduced in size, or eliminated altogether. In an alternative embodiment the grid is recalculated based on the operator's action. In this way, the grid becomes interactive and decreases in noisiness as the operator engages with the data.

In an embodiment, curated persons of interest appear in a separate panel adjacent to the grid. Drilling into one of the curated persons (by clicking) will update the grid such that only faces deemed similar to that person (within a threshold) are displayed. Faces in the drilled-down version of the grid have a visual indicator of how similar they are to the curated person. One implementation is highlighting and dimming as described above. Another implementation is an additional visual annotation demarcating “high”, “medium”, and “low” confidence matches.

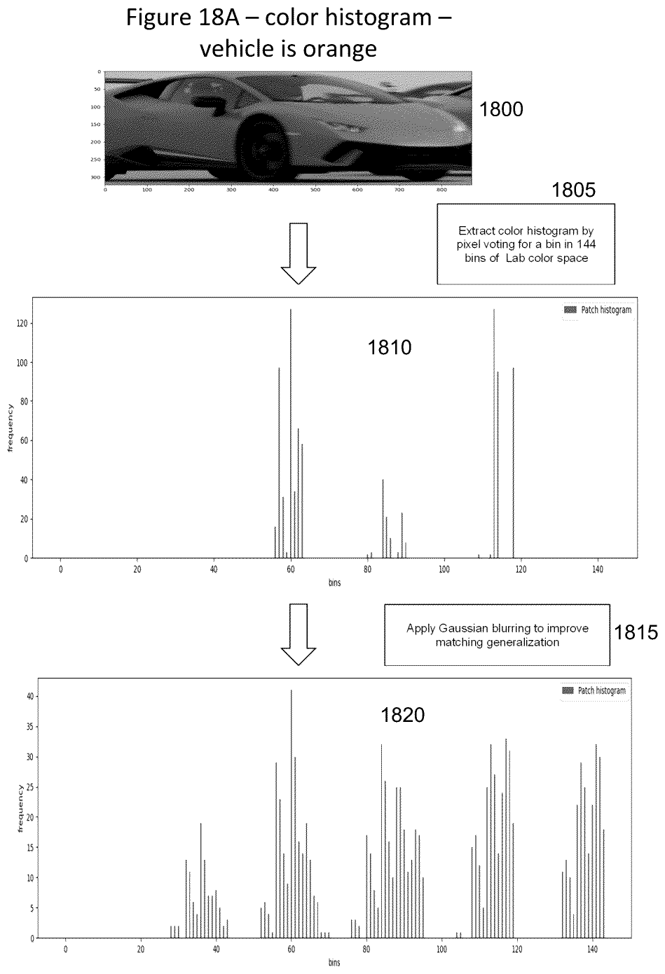

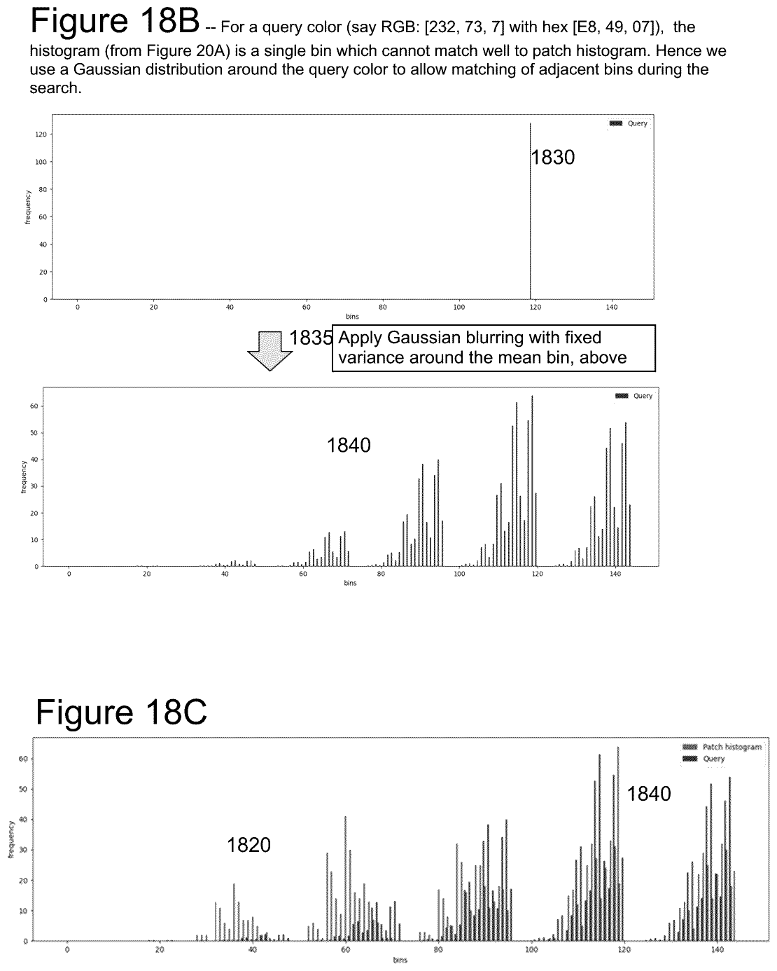

It will be appreciated that, in some embodiments, no human operator 1700 is involved and the foregoing steps where a human might be involved are instead fully automated. This can be particularly true for applications which tolerate lower thresholds of accuracy, such as fruit packing, customer loyalty programs, and so on. Referring next to FIGS. 18A-18C, a still further aspect of some embodiments of the present invention can be better appreciated. FIGS. 18A-18C illustrate the use of color as an element of a query. In many searches for objects, color is a fundamental requirement for returning useful search results. Color is usually defined in the context of a “color space”, which is a specific organization of colors. The usual reference standard for defining a color space is the CIELAB or CIEXYZ color space, often simply referred to as Lab. In the Lab color space, “L” stands for perceptual lightness, from black to white, while “a” denotes colors from green to red and “b” denotes colors from blue to yellow. Representation of color in the Lab color space can thus be thought of as a point in three-dimensional Space, where “L” is one axis, “a” another, and “b” the third.

In an embodiment, a 144-dimensional histogram in Lab color space is used to perform a color search. Lab histograms use four bins in the L axis, and six bins in each of the “a” and “b” axes. For queries seeking an object where the query includes color as a factor, such as a search for an orange car of the sort depicted at 1800 in FIG. 18A, a patch having the color of interest is selected and a color histogram is extracted, again using Lab color space. For convenience of illustration, in FIG. 18A Lab color space is depicted on a single axis by concatenating the values. This appears as a plurality of different peaks as shown at 1810.

Because colors from patches will have natural variance due to the variety of lighting conditions under which the image was captured, whereas a query color typically is a point in Lab color space with zero variance, artificial variance is added to the query to allow matching with colors that are close to the query color. This is achieved by using Gaussian blurring on the query color, 1815, which results in the variety of peaks shown at 1820 in FIG. 18A.

The query color, essentially a single point in Lab color space, is plotted at 1830. Again Gaussian blurring is applied, such that the variety of peaks shown at 1840 result. Then, at FIG. 18C, the Gaussian plot of the patch histogram is overlaid on the Gaussian plot of the query color, with the result that a comparison of the query color and patch color can be made. Matching between the two 144-dim histograms h1 and h2 is performed as:

Σi[0.5*min(h1[i],h2[i])2/(h1[i]+h2[i])]

Depending upon how a threshold for comparison is selected, the object that provided the patch—e.g., the car 1800—is either determined to be a match to the query color or not.

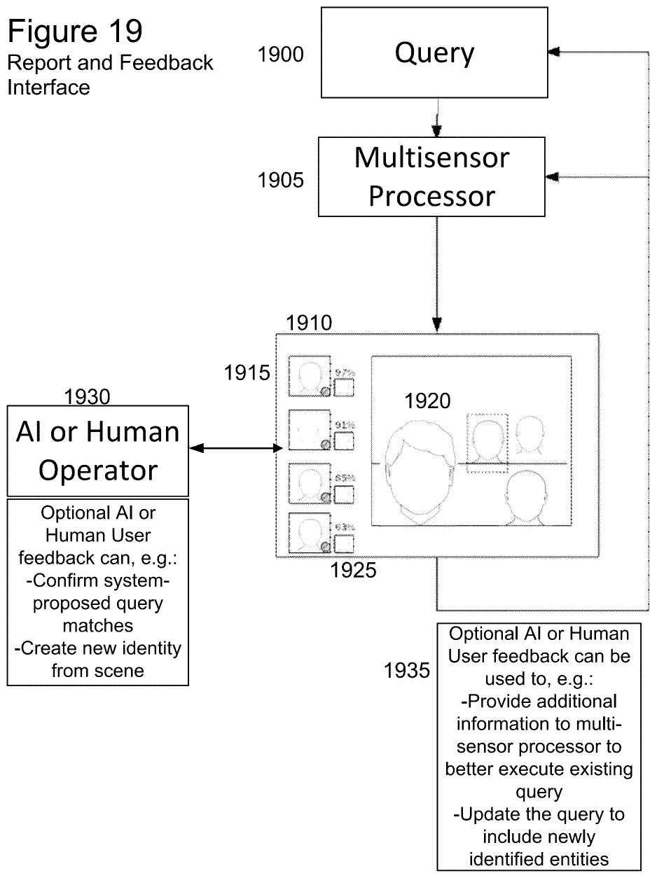

Referring next to FIG. 19, a report and feedback interface to a user can be better appreciated. A query 1900 is generated either automatically by the system, such as in response to an external event, or at a preset time, or some other basis, or by human operator 1915. The query is fed to the multisensor processor 1905 discussed at length herein, in response to which a search result is returned for display on the device 1910. The display of the search results can take numerous different forms depending upon the search query and the type of data being searched. In some embodiments as discussed herein, the search results will typically be a selection of faces or objects 1915 that are highly similar to a known image, and in such instances the display 1910 may have the source image 1920 displayed for comparison to the images selected by the search. In other embodiments, the presentation of the search results on the display may be a layout of images such as depicted in FIGS. 16A-16C, including highlighting, dimming or other audio or visual aids to assist the user. In any case, system confidence in the result can be displayed as a percentage, 1925. If operator feedback is permitted in the particular embodiment, the operator 1930 can then confirm system-proposed query matches, or can create new identities, or can provide additional information. Depending upon the embodiment and the information provided as feedback, one or more of the processes described herein may iterate, 1935, and yield further search results.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

1. A method for identifying at least an individual from among a plurality of individuals recorded in a sequence of frames of image data, the method comprising:
receiving in a processor-based system a sequence of the frames recorded over a period of time, wherein each frame captures images of the faces of a plurality of individuals,
identifying in the system, from the images, a face of each of a plurality of individuals recorded in each of a plurality of the frames and extracting by an embedding network an embedding representative of at least some invariant features of each identified face,
based at least in part on the embedding of each identified face, assigning a greater confidence to images identified as the same person in substantially consecutive frames than to images identified as the same person but not in substantially consecutive frames,
at least in part in response to the embeddings, automatically grouping images identified as the same person and having substantially the same confidence, and
from each grouping of images, automatically selecting in a processor-based system an image for presentation to a user as representative of all of the images of the person in the grouping.

2. A method for segregating images of at least an object from among a plurality of objects recorded in a sequence of frames of image data, the method comprising:
receiving in a processor-based system a sequence of the frames recorded over a period of time, wherein each frame captures images of the objects,
identifying in the system, from the images, each of a plurality of objects recorded in each of a plurality of the frames and extracting by an embedding network an embedding representative of at least some invariant features of each identified object,
based at least in part on the embedding of each identified object, assigning a greater confidence to images identified as the same object in substantially consecutive frames than to images identified as the same object but not in substantially consecutive frames,
at least in part in response to the embeddings, automatically grouping images identified as the same object and having substantially the same confidence, and
from each grouping of images, automatically selecting in a processor-based system an image for presentation to a user as representative of all of the images of the object in the grouping.

3. A method for identifying at least two objects from among a plurality of objects recorded in a sequence of frames of image data, the method comprising:
receiving in a processor-based system a sequence of the frames recorded over a period of time, wherein each frame captures images of a plurality of objects,
identifying in the system, from the images, each of the plurality of objects recorded in each of a plurality of the frames and extracting by an embedding network an embedding representative of at least some invariant features of each identified object,
in response to a query having a parse tree comprising literals and based at least in part on the embedding of each identified object, automatically assessing a relationship between at least two of the identified objects including assigning a confidence based at least in part on the distance between the embedding for the identified object and the embedding for any sample provided for the literal,
automatically grouping images identified as satisfying the query with substantially the same confidence, and
from each grouping of images, automatically selecting from each group at least one image for presentation to a user as representative of the query response.

4. A method for sorting and compressing a quantity of frames of image data to enable an ‘at a glance’ assessment of various objects within those frames comprising
receiving in a processor-based system at least some of the frames, the frames being consecutive with respect to at least one of a group comprising time, landmark and geospatial location, the frames comprising images of a plurality of objects,
inputting at least some of the images from a first of the consecutive frames into an embedding network to generate an embedding representative of invariant features of each of the objects captured in the images,
inputting into the embedding network at least some images from a second of the consecutive frames and using the embeddings generated from the first frame as a reference for generating embeddings representative of the objects in the second frame,
repeating the inputting and generating steps, using the previously generated embeddings as a reference for generating embeddings of the objects captured by the images in each subsequent consecutive frame,
automatically aggregating into tracklets embeddings from the consecutive frames that are identified as the same object based at least in part on embedding distance, and choosing a representative image for the tracklet,
automatically aggregating into clusters tracklets whose embeddings are sufficiently similar that the distance between their embeddings is less than a first predetermined threshold.

5. The method of claim 4 further comprising the step of aggregating into groups tracklets whose relative embedding distance is less than a second predetermined threshold to provide an additional level of granularity.

6. The method of claim 2 wherein the identifying step is initiated in response to a query, and color is an element of the query.

7. The invention of claim 2 wherein the objects comprise at least faces.

8. The invention of claim 4 wherein the objects comprise at least faces.

9. The invention of claim 4 wherein color is a factor in determining the embedding of an object.

10. A system for sorting and compressing a quantity m frames of image data to enable an ‘at a glance’ assessment of various faces within those frames comprising
at least one processor configured for bidirectional communications with data storage and configured to:
receive in the data storage at least some of the frames, the frames being consecutive with respect to at least one of a group comprising time, landmark and geospatial location and comprising images of a plurality of faces,
generate a first embedding representative of invariant features of at least some of the faces from among the plurality of faces in a first of the consecutive frames,
for each successive frame, generate for at least some of the faces of the then-current frame n, where n is not greater than m, a representative embedding where the embedding for each such face uses as a reference the embeddings for faces in the first frame through the nth−1 frame,
automatically aggregate into tracklets embeddings from the consecutive frames that are identified as the same face based at least in part on embedding distance, and choosing a representative image for the tracklet, and
for each tracklet, automatically select for display to a user a representative image that includes at least most of the invariant features of the associated face.

11. A non-transitory computer readable storage medium comprising stored instructions to identify an individual from among a population of individuals recorded in a sequence of frames of video data, the instructions when executed causing at least one processor and data storage in communication therewith to:
receive in the data storage at least some of the frames, the frames being substantially sequential with respect to at least one of a group comprising time, landmark and geospatial location and comprising images of a plurality of faces of individuals,
generate a first embedding representative of invariant features of at least some of the faces from among the plurality of faces in a first of the consecutive frames,
for each successive frame, generate for at least some of the faces of the then-current frame n, where n is not greater than m, a representative embedding where the embedding for each such face uses as a reference the embeddings for faces in the first frame through the nth−1 frame,
automatically aggregate into tracklets embeddings from the consecutive frames that are identified as the same face based at least in part on embedding distance, and choosing a representative image for the tracklet, and
for each tracklet, automatically select for display to a user a representative image that includes at least most of the invariant features of the associated face.
